(19) United States
(12) Patent Application Publication
(10) Pub. No.: US 2018/0044507 A1
(43) Pub. Date: Feb. 15, 2018

(54) POLYESTER FILM AND ELECTRICAL INSULATION SHEET MANUFACTURED USING SAME, WIND POWER GENERATOR, AND ADHESIVE TAPE

(71) Applicant: Toray Industries, Inc., Tokyo (JP)

(72) Inventors: Shohei Yoshida, Otsu-shi (JP); Risa Hamasaki, Otsu-shi (JP); Shigeru Aoyama, Otsu-shi (JP); Jun Sakamoto, Mishima-shi (JP)

(21) Appl. No.: 15/554,775

(22) PCT Filed: Jan. 28, 2016
(86) PCT No.: PCT/JP2016/052522

§ 371 Date: Aug. 31, 2017

(30) Foreign Application Priority Data
Mar. 5, 2015 (JP) 2015-043274
Jul. 30, 2015 (JP) 2015-150354
Sep. 2, 2015 (JP) 2015-172504

(51) Int. Cl. C08K 7/00; B29C 47/00; B29C 71/02; B29C 55/00; B29C 55/14; C09J 167/02; C08K 3/34; C08K 3/38; C08K 3/22; C08J 3/20; C09J 7/00; C09J 11/04; B29B 13/06; B29C 47/88

(52) U.S. Cl. CPC C08K 7/00; B29B 13/065; B29C 47/0004; B29C 47/0021; B29C 47/0057; B29C 71/02; B29C 55/005; B29C 55/14; B29C 47/8845; C08K 3/34; C08K 3/38; C08K 3/22; C08J 3/203; C09J 7/00; C09J 11/04; C09J 167/02; B29K 2995/0053; B29L 2007/008

(57) ABSTRACT

A polyester film provided with a layer (a P layer) that contains a crystalline polyester (A) also contains plate-like particles (b1) each having an aspect ratio of 2 or more and/or needle-like particle (b2) each having an aspect ratio of 2 or more, wherein the Young's modulus of the polyester film is 2 GPa or more and the values of Wb and V/Wb are 10 or more and 1 or less, respectively, wherein Wb (% by mass) represents the total content of the plate-like particles (b1) and the needle-like particles (b2) in the P layer, and V (% by volume) represents the porosity in the P layer.

### TECHNICAL FIELD

This disclosure relates to a polyester film. The disclosure also relates to an electrical insulation sheet, a wind power generator, and adhesive tape containing the film.

### BACKGROUND

Polyester resins (in particular, poly(ethylene terephthalate), poly(ethylene-2,6-naphthalenedicarboxylate) and the like) are excellent in mechanical properties, thermal properties, chemical resistance, electrical properties, and formability and therefore used in various applications. Films made of the polyester resins (called polyester films), in particular, biaxially oriented polyester films are excellent in mechanical properties, electrical properties and the like and therefore used in electrical insulating materials such as copper-clad laminates, solar-cell back sheets, adhesive tape, flexible printed boards, membrane switches, heating element sheets, flat cables, and motor insulating materials, as well as in magnetic recording materials, capacitor materials, packaging materials, automobile materials, building materials, and various other industrial materials for applications such as photographing, graphics, and thermal transfer.

Electrical insulating materials for motors and other uses (such as insulating sheets for wind power generation, sheets for hybrid motors, and sheets for motors in air conditioners), among these, have the following problem: as motors are becoming smaller with higher density, for example, heat generated during power generation and during use accumulates and causes a rise in temperature, which results in a decrease in power generation efficiency and an increase in power consumption. Solar-cell back sheet materials, for example, have the same problem that heat generated during power generation accumulates and causes a rise in temperature to lead to a decrease in power generation efficiency. For these reasons, it has been important to transfer and dissipate internal heat to outside. In addition, electrical insulating materials for use in electronic components (such as adhesive tape, flexible printed boards, and membrane switches for electronic components) have problems like the following one: along with the recent trend of electronic components toward high performance, smaller sizes, and enhanced integration, the amount of heat generated from various electronic components has become greater and been causing a decrease in processing speed and an increase in power consumption. For this reason, it has been important to release internal heat to outside through the cabinet.

Under these circumstances, films having excellent thermal conductivity are demanded and various materials have been proposed. For example, a composite film produced by using a graphite sheet, which has excellent thermal conductivity, and then laminating a PET film as a protective layer to one side or both sides of the graphite sheet (JP 2008-80672 A) and a film composed of a biaxially stretched PET film containing fibrous carbon material (JP 2013-28753 A and JP 2013-38179 A) are proposed.

However, the technique of JP '672 has such problems that the graphite sheet is brittle and poor in mechanical properties, the thermal conductive rate of the PET film as the protective layer is low and not enough for allowing the graphite film to fully display its excellent thermal conductive rate, and the composite film is thick. The techniques of JP '753 and JP '179 also have problems that the film is conductive and therefore not suitable for applications where insulation is required such as in motor insulating materials, solar-cell back sheets, and electronic components.

Thus, it could be helpful to provide a polyester film excellent in electrical insulating properties, thermal conductivity, and mechanical properties.

### SUMMARY

We thus provide:
(1) A polyester film having a layer (P layer), the layer containing a crystalline polyester (A) and at least one of a plate-like particle (b1) having an aspect ratio of 2 or more and a needle-like particle (b2) having an aspect ratio of 2 or more, in which the polyester film has a Young's modulus of 2 GPa or more, a Wb value of not smaller than 10, and a V/Wb value of not greater than 1, with Wb (% by mass) being the total content of the plate-like particle (b1) having an aspect ratio of 2 or more and the needle-like particle (b2) having an aspect ratio of 2 or more in the P layer and V (% by volume) being the porosity of the P layer.
(2) The polyester film according to (1), in which the plate-like particle (b1) having an aspect ratio of 2 or more and the needle-like particle (b2) having an aspect ratio of 2 or more each have on a surface a substituent reactive with the crystalline polyester (A) (hereinafter, the substituent is called reactive substituent (a)), and the amount of the reactive substituent (a) on a unit surface area of the particle (B) is not smaller than 0.2×10⁻⁶ mol/m² and not greater than 1.4×10⁻⁴ mol/m².
(3) The polyester film according to (1) or (2), in which the P layer contains both the plate-like particle (b1) having an aspect ratio of 2 or more and the needle-like particle (b2) having an aspect ratio of 2 or more, and a Wb2/Wb1 value is not smaller than 0.7 and not greater than 9, with the content of the plate-like particle (b1) having an aspect ratio of 2 or more in the P layer being Wb1 (% by mass) and the content of the needle-like particle (b2) having an aspect ratio of 2 or more in the P layer being Wb2 (% by mass).
(4) The polyester film according to any one of (1) to (3), in which the elongation at break of the polyester film is not lower than 10%.
(5) The polyester film according to any one of (1) to (4), in which the difference (ΔTcg) between the glass transition temperature (Tg) of the P layer and the cold crystallization peak top temperature (Tcc) of the P layer is not lower than 44° C.
(6) The polyester film according to (1) to (5), in which a dynamic storage elastic modulus (E′) at 100° C. determined by dynamic viscoelasticity measurement (hereinafter, called DMA) at a frequency of 1 Hz is not smaller than 5×10⁷ Pa.
(7) The polyester film according to any one of (1) to (6), in which the polyester film has a thermal conductive rate in a film thickness direction of not lower than 0.15 W/mK and a surface specific resistance of not lower than 10¹³ Ω/□.
(8) An electrical insulation sheet having the polyester film as described in any one of (1) to (7).
(9) A wind power generator having the electrical insulation sheet as described in (8).
(10) Adhesive tape having the polyester film as described in any one of (1) to (7).
(11) A method of producing the polyester film as described in any one of (1) to (7), the method including, in sequence:
   melt-kneading the crystalline polyester (A) with at least one of the plate-like particle (b1) having an aspect ratio of 2 or more and having the substituent reactive with the crystalline polyester (A) (hereinafter, the substituent is called reactive substituent (a)) on the surface and the needle-like particle (b2) having an aspect ratio of 2 or more and having the reactive substituent (a) on the surface (hereinafter, the step is called melt-kneading step);
   melting the resulting resin composition containing the crystalline polyester (A) and the at least one particle and discharging the resulting resin composition through a nozzle to obtain a film (hereinafter, the step is called melt-extruding step); and
   biaxially stretching the resulting film (hereinafter, the step is called stretching step).
(12) The method of producing the polyester film according to (11), in which the amount of the reactive substituent (a) on a unit surface area of the at least one of the plate-like particle (b1) having an aspect ratio of 2 or more and the needle-like particle (b2) having an aspect ratio of 2 or more is not smaller than 0.2×10⁻⁶ mol/m² and not greater than 1.4×10⁻⁴ mol/m².
(13) The method of producing the polyester film according to (11) or (12), in which the at least one of the plate-like particle (b1) having an aspect ratio of 2 or more and the needle-like particle (b2) having an aspect ratio of 2 or more has been treated with a surface-treating agent containing the reactive substituent (a), and the proportion (by mass) of the surface-treating agent is not lower than 0.1 parts by mass and not higher than 5 parts by mass relative to the mass of the particle (B) being defined as 100 parts by mass.
(14) The method of producing the polyester film according to any one of (11) to (13), in which the melt-kneading step yields a chip-like composition, then the resulting chip-like composition is subjected to solid-phase polymerization, and then the resultant is melted and subjected to film formation in the melt-extruding step.

We provide a polyester film excellent in electrical insulating properties, thermal conductivity, and mechanical properties compared to conventional polyester films. The polyester film can be suitably used in applications where electrical insulating properties and thermal conductivity are both important, namely, applications including electrical insulating materials such as copper-clad laminates, solar-cell back sheets, adhesive tape, flexible printed boards, membrane switches, heating element sheets, and flat cables as well as capacitor materials, automobile materials, and building materials. More specifically, the polyester film can be used to provide highly efficient wind power generators and solar cells and low-power-consuming small electronic devices.

### BRIEF DESCRIPTION OF THE DRAWING

FIG. 1 schematically illustrates a particle enclosed in a circumscribing rectangular parallelepiped.

### DESCRIPTION OF REFERENCE SIGNS

1: Length (l)
2: Width (b)
3: Thickness (t)

### DETAILED DESCRIPTION

Our polyester film needs to have a layer (P layer) that contains a crystalline polyester (A) and at least one of a plate-like particle (b1) having an aspect ratio of 2 or more and a needle-like particle (b2) having an aspect ratio of 2 or more (hereinafter, the plate-like particle (b1) having an aspect ratio of 2 or more and the needle-like particle (b2) having an aspect ratio of 2 or more are sometimes collectively called particle (B)).

The crystalline polyester (A) in the polyester film is a polyester containing a dicarboxylic acid constituent and a diol constituent as main constituents, and is also a resin having a ΔHm value (amount of heat for crystal melting) of not lower than 15 J/g. The ΔHm value is determined as follows: the resin is heated from 25° C. to 300° C. at a temperature raising rate of 20° C./minute (1st RUN), then maintained for 5 minutes, then rapidly cooled to a temperature of not higher than 25° C., and then reheated from room temperature to 300° C. at a temperature raising rate of 20° C./min (2nd RUN), in accordance with JIS K-7122 (1987); and in a differential scanning calorimetry chart obtained for the 2nd RUN, the peak area in a melting peak is used to determine the ΔHm value. The ΔHm value (amount of heat for crystal melting) of the resin is more preferably not lower than 20 J/g, further preferably not lower than 25 J/g, particularly preferably not lower than 30 J/g. When the polyester constituting the P layer is the crystalline polyester (A), it is easy to perform orientation and crystallization in a production method described below and a highly heat-resistant film can be obtained. In the present specification, a constituent refers to the smallest unit possibly obtained by hydrolysis of the polyester.

Non-limiting examples of the dicarboxylic acid constituent of the polyester include aliphatic dicarboxylic acids such as malonic acid, succinic acid, glutaric acid, adipic acid, suberic acid, sebacic acid, dodecanedioic acid, dimer acids, eicosanedioic acid, pimelic acid, azelaic acid, methylmalonic acid, and ethylmalonic acid, alicyclic dicarboxylic acids such as adamantane dicarboxylic acid, norbornene dicarboxylic acid, isosorbide, cyclohexane dicarboxylic acid, and decalindicarboxylic acid, aromatic dicarboxylic acids such as terephthalic acid, isophthalic acid, phthalic acid, 1,4-naphthalene dicarboxylic acid, 1,5-naphthalene dicarboxylic acid, 2,6-naphthalene dicarboxylic acid, 1,8-naphthalene dicarboxylic acid, 4,4′-diphenyldicarboxylic acid, 4,4′-diphenyl ether dicarboxylic acid, 5-sulfoisophthalic acid sodium salt, anthracene dicarboxylic acid, phenanthrene dicarboxylic acid, and 9,9′-bis(4-carboxyphenyl)fluorene acid, and ester derivatives thereof. Also preferable are, for example, these carboxylic acid constituents having a terminal carboxy group to which oxyacids such as l-lactide, d-lactide, and hydroxybenzoic acid, derivatives thereof, or several oxyacids linked to each other are added. One of these carboxylic acid constituents may be used alone, or a plurality of these carboxylic acid constituents may be used together as needed.

Non-limiting examples of the diol constituent of the polyester include diols, for example, aliphatic diols such as ethylene glycol, 1,2-propanediol, 1,3-propanediol, 1,4-butanediol, 1,2-butanediol, and 1,3-butanediol, alicyclic diols such as cyclohexanedimethanol, spiroglycol, and isosorbide, bisphenol A, 1,3-benzenedimethanol, 1,4-benzenedimethanol, 9,9′-bis(4-hydroxyphenyl) fluorene, and aromatic diols. The diol constituent may also be several of these diols linked to each other. One of these diol constituents may be used alone, or a plurality of these diol constituents may be used together as needed.

In the crystalline polyester (A) in the P layer of the polyester film, the proportion of the amount of an aromatic dicarboxylic acid constituent in the total amount of the dicarboxylic acid constituent is preferably not lower than 90 mol % and not higher than 100 mol %, more preferably not lower than 95 mol % and not higher than 100 mol %, further preferably not lower than 98 mol % and not higher than 100 mol %, particularly preferably not lower than 99 mol % and not higher than 100 mol %. Most preferably, the proportion is 100 mol %, in other words, the dicarboxylic acid constituent is exclusively an aromatic carboxylic acid constituent. When the proportion is lower than 90 mol %, heat resistance may be low. When the proportion of the amount of an aromatic dicarboxylic acid constituent in the total amount of the dicarboxylic acid constituent in the crystalline polyester (A) in the P layer of the polyester film is not lower than 90 mol % and not higher than 100 mol %, it is easy to perform orientation and crystallization in the production method described below and the resulting polyester film can be highly heat-resistant.

A repeating unit forming the crystalline polyester (A) in the P layer of the polyester film, more specifically, a main repeating unit consisting of the dicarboxylic acid constituent and the diol constituent suitably has and preferably is ethylene terephthalate, ethylene-2,6-naphthalenedicarboxylate, propylene terephthalate, butylene terephthalate, 1,4-cyclohexylenedimethylene terephthalate, and/or ethylene-2,6-naphthalenedicarboxylate. The main repeating unit herein refers to a repeating unit the total amount of which accounts to not lower than 80 mol %, more preferably not lower than 90 mol %, further preferably not lower than 95 mol % of the total amount of repeating units.

From the viewpoints of low cost, easy polymerization, and excellent heat resistance, it is further preferable that the main repeating unit be ethylene terephthalate and/or ethylene-2,6-naphthalenedicarboxylate. When the main repeating unit is ethylene terephthalate, the resulting film can be versatile, excellent in heat resistance, and obtainable at low cost. When the main repeating unit is ethylene-2,6-naphthalenedicarboxylate, the resulting film can be even more excellent in heat resistance.

Although the crystalline polyester (A) in the P layer of the polyester film can be obtained by appropriately combining the constituents (the dicarboxylic acid constituent and the diol constituent) and subjecting these constituents to polycondensation, it is also preferable that the crystalline polyester be obtained by copolymerizing these constituents with, for example, an additional constituent having three or more carboxy groups and/or hydroxy groups. In the latter case, the proportion of the additional constituent having three or more carboxy groups and/or hydroxy groups in all the constituents of the crystalline polyester (A) subjected to copolymerization is preferably not lower than 0.005 mol % and not higher than 2.5 mol %.

An intrinsic viscosity (hereinafter, called IV) of the crystalline polyester (A) in the P layer of the polyester film is preferably not lower than 0.6, more preferably not lower than 0.65, further preferably not lower than 0.68, particularly preferably not lower than 0.7. When the IV value is too low, the degree of intermolecular entanglement with the particle (B) (described below) is too low, potentially resulting in no mechanical physical properties obtained, or potentially resulting in a tendency toward an over-time decrease in mechanical properties to cause embrittlement. When the IV value of the crystalline polyester in the P layer of the polyester film is not lower than 0.6, excellent mechanical properties can be obtained. The upper limit to the IV value is not particularly set. However, a too high IV value may lead to a long polymerization time, which is disadvantageous in terms of cost, or may lead to difficult melt-extrusion. Thus, the IV value is preferably not higher than 1.0, further preferably not higher than 0.9.

To obtain the polyester having the IV value specified above, the following methods can be employed: melt-polymerization to obtain a certain melt viscosity as determined in advance, followed by discharging, strand forming, and cutting to form chips having the IV value specified above; and formation of chips having an intrinsic viscosity lower than the desired value, followed by solid-phase polymerization to obtain the polyester having the IV value specified above. It is preferable to perform formation of chips having an intrinsic viscosity lower than the desired value followed by solid-phase polymerization, among these methods, because this method can reduce thermal degradation and also reduce the number of terminal carboxy groups particularly in the case where the IV value is to be made not lower than 0.65. For further enhancing the IV value of the film, it is more preferable to perform the method described below in which the crystalline polyester (A) containing the particle (B) is subjected to solid-phase polymerization. In this case, excessive crystallization is inhibited during film formation by the production method described below in which the crystalline polyester (A) contains the particle (B), resulting in enhanced stretchability and enhanced mechanical properties of the resulting film.

A melting point (Tm) of the crystalline polyester (A) in the P layer of the polyester film is preferably not lower than 240° C. and not higher than 290° C. The melting point (Tm) herein is a melting point (Tm) measured by DSC while the temperature is being raised (at a temperature raising rate of 20° C./min). The melting point (Tm) of the crystalline polyester (A) is determined as follows: heating is performed from 25° C. to a temperature 50° C. higher than the melting point of the polyester at a temperature raising rate of 20° C./minute (1st RUN), then maintained for 5 minutes, then rapidly cooled to a temperature of not higher than 25° C., and then reheated from room temperature to 300° C. at a temperature raising rate of 20° C./min (2nd RUN), by a method in accordance with JIS K-7121 (1987); and the temperature at the top of the crystal melting peak obtained for the 2nd RUN is used as the melting point (Tm) of the crystalline polyester (A). The melting point (Tm) is more preferably not lower than 245° C. and not higher than 275° C., further preferably not lower than 250° C. and not higher than 265° C. A melting point (Tm) lower than 240° C. is unpreferable because the heat resistance of the film may be low, and a melting point (Tm) higher than 290° C. is also unpreferable because it may be difficult to perform extrusion processing. When the melting point (Tm) of the crystalline polyester (A) in the P layer of the polyester film is not lower than 245° C. and not higher than 290° C., the resulting polyester film can be heat-resistant.

The number of terminal carboxy groups in the crystalline polyester (A) in the P layer of the polyester film is preferably not greater than 40 equivalents/t, more preferably not greater than 30 equivalents/t, further preferably not greater than 20 equivalents/t. When the number of terminal carboxy groups is too great, catalytic action of protons derived from terminal carboxy groups is strong even after structure control, whereby hydrolysis and thermal decomposition are promoted and then degradation of the polyester film tends to proceed more than in a typical case. When the number of terminal carboxy groups is within the range described above, degradation (such as hydrolysis and thermal decomposition) of the polyester film can be reduced. The number of terminal carboxy groups can be controlled to not greater than 40 equivalents/t by using a polyester obtained by a combination of the following methods, for example: 1) esterification reaction of the dicarboxylic acid constituent and the diol constituent, then melt polymerization to obtain a certain melt viscosity as determined in advance, followed by discharging, strand forming, and cutting to form chips, further followed by solid-phase polymerization; and 2) addition of a buffer after the completion of transesterification reaction or esterification reaction and before an early stage of polycondensation reaction (namely, while the intrinsic viscosity is lower than 0.3). Alternatively, the number of terminal carboxy groups can be controlled by adding a buffer and/or a terminus-blocking agent during formation. The terminus-blocking agent is a compound that reacts with and binds to a terminal carboxy group or a terminal hydroxy group of the polyester and inhibits the catalytic activity of protons derived from the terminal group. Specific examples of the terminus-blocking agent include compounds containing a substituent such as an oxazoline group, an epoxy group, a carbodiimide group, and/or an isocyanate group. When an anti-hydrolysis agent is used, the amount of the anti-hydrolysis agent is preferably not lower than 0.01 mass %, more preferably not lower than 0.1 mass %, relative to the amount of the P layer. When the anti-hydrolysis agent is added in combination with the polyester, degradation of the polyester attributed to addition of the particle can be reduced and mechanical properties and heat resistance can be further enhanced. If the amount of the anti-hydrolysis agent is too great, flame retardancy may be reduced. Therefore, the upper limit to the amount of the anti-hydrolysis agent is preferably not greater than 2 mass %, more preferably not greater than 1 mass %, further preferably not greater than 0.8% mass %, relative to the amount of the P layer.

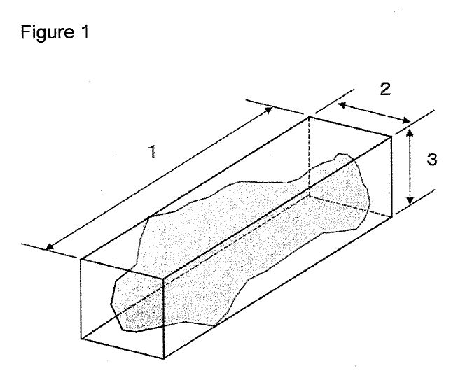

The P layer of the polyester film needs to contain at least one of the plate-like particle (b1) having an aspect ratio of 2 or more and the needle-like particle (b2) having an aspect ratio of 2 or more (hereinafter, the plate-like particle (b1) having an aspect ratio of 2 or more and the needle-like particle (b2) having an aspect ratio of 2 or more are sometimes collectively called particle (B)). The plate-like particle (b1) having an aspect ratio of 2 or more herein is a particle that when a primary particle thereof is circumscribed in a hypothetical rectangular parallelepiped as shown in FIG. 1 with the longest side being regarded as equivalent to the length (l) of the particle, the shortest side being regarded as equivalent to the thickness (t) of the particle, and the remaining side being regarded as equivalent to the width (b) of the particle, the ratio (l/t) of the length (l) to the thickness (t) is not lower than 2 and the ratio (l/b) of the length (l) to the width (b) is not lower than 1 and not higher than 2. The needle-like particle (b2) having an aspect ratio of 2 or more herein is a particle that when a primary particle thereof is circumscribed in a hypothetical rectangular parallelepiped as shown in FIG. 1 with the longest side being regarded as equivalent to the length (l) of the particle, the shortest side being regarded as equivalent to the thickness (t) of the particle, and the remaining side being regarded as equivalent to the width (b) of the particle, the ratio (l/t) of the length (l) to the thickness (t) is not lower than 2 and the ratio (l/b) of the length (l) to the width (b) is higher than 2. The aspect ratio herein is the ratio (l/t) of the length (l) to the thickness (t) of the plate-like particle or the needle-like particle. When the polyester film contains the plate-like particle or the needle-like particle having an aspect ratio of 2 or more, the probability at which particles come into contact with each other is higher than the case in which the polyester film contains a spherical particle instead. The probability at which particles come into contact with each other increases with the aspect ratio. When the total content (Wb) of the plate-like particle (b1) having an aspect ratio of 2 or more and the needle-like particle (b2) having an aspect ratio of 2 or more in the P layer of the polyester film is not lower than 10 mass %, the resulting polyester film can be thermally conductive. The aspect ratio is more preferably not lower than 3, further preferably not lower than 5. The upper limit to the aspect ratio is not particularly limited, but is preferably not higher than 40, further preferably not higher than 30, to prevent breakage or cracking of the particle (B) while the particle is kneaded into the resin.

The total content (Wb) (% by mass) of the plate-like particle (b1) having an aspect ratio of 2 or more and the needle-like particle (b2) having an aspect ratio of 2 or more in the P layer needs to be not lower than 10 mass %, more preferably not lower than 12 mass % and not higher than 50 mass %, further preferably not lower than 15 mass % and not higher than 40 mass %, particularly preferably not lower than 18 mass % and not higher than 35 mass %. When the total content is lower than 10 mass %, the probability at which particles come into contact with each other is low, resulting in a decrease in the thermal conductive rate. When the total content is higher than 50 mass %, the film-forming properties and the after-stretching mechanical properties of the resulting film are poor.

The length (l) of each of the plate-like particle (b1) and the needle-like particle (b2) in the polyester film is preferably not smaller than 1 μm and not greater than 80 μm, more preferably not smaller than 2 μm and not greater than 40 μm, further preferably not smaller than 3 μm and not greater than 20 μm. When the length (l) is smaller than 1 μm, the area of the interface is too large and the thermal conductivity may be low. When the length (l) is greater than 80 μm, film-forming properties may be poor, in particular stretchability in a stretching step described below may decrease, resulting in low productivity. When the length of each of the plate-like particle (b1) and the needle-like particle (b2) in the polyester film is not smaller than 1 μm and not greater than 80 μm, thermal conductivity and film-forming properties can be both obtained, which is preferable.

Examples of the material of each of the plate-like particle (b1) and the needle-like particle (b2) in the polyester film include metals such as gold, silver, copper, platinum, palladium, rhenium, vanadium, osmium, cobalt, iron, zinc, ruthenium, praseodymium, chromium, nickel, aluminum, tin, zinc, titanium, tantalum, zirconium, antimony, indium, yttrium, and lanthanum, metal oxides such as zinc oxide, titanium oxide, cesium oxide, antimony oxide, tin oxide, indium tin oxide, yttrium oxide, lanthanum oxide, zirconium oxide, aluminum oxide, magnesium oxide, and silicon oxide, metal fluorides such as lithium fluoride, magnesium fluoride, aluminum fluoride, and cryolite, metal phosphates such as calcium phosphate, carbonates such as calcium carbonate, sulfates such as barium sulfate and magnesium sulfate, nitrides such as silicon nitride, boron nitride, and carbon nitride, silicates such as wollastonite, sepiolite, and xonotlite, titanates such as potassium titanate and strontium titanate, and carbon compounds such as carbon, fullerene, carbon fiber, carbon nanotube, and silicon carbide. Two or more of these particles may be used together.

As the polyester film tends to be used in applications where electrical insulating properties are required, the material of each of the plate-like particle (b1) and the needle-like particle (b2) is preferably a material that has no conductivity, for example, a metal oxide such as zinc oxide, titanium oxide, cesium oxide, antimony oxide, tin oxide, indium tin oxide, yttrium oxide, lanthanum oxide, zirconium oxide, aluminum oxide, magnesium oxide, or silicon oxide, a metal fluoride such as lithium fluoride, magnesium fluoride, aluminum fluoride, or cryolite, a metal phosphate such as calcium phosphate, a carbonate such as calcium carbonate, a sulfate such as barium sulfate or magnesium sulfate, a nitride such as silicon nitride, boron nitride, or carbon nitride, a silicate such as wollastonite, sepiolite, or xonotlite, or a titanate such as potassium titanate. When such a material is used, insulating properties of the particle are exhibited and thereby long-term electrical insulating properties that constitute the desired effect are remarkably exhibited.

The polyester film has a layer (P layer), the layer containing the crystalline polyester (A) and at least one of the plate-like particle (b1) having an aspect ratio of 2 or more and the needle-like particle (b2) having an aspect ratio of 2 or more, in which the total content (Wb) of the plate-like particle (b1) having an aspect ratio of 2 or more and the needle-like particle (b2) having an aspect ratio of 2 or more in the P layer is not lower than 10 mass %.

Although the P layer is simply required to contain at least one of the plate-like particle (b1) having an aspect ratio of 2 or more and the needle-like particle (b2) having an aspect ratio of 2 or more, it is more preferable that the layer contain both the plate-like particle (b1) and the needle-like particle (b2). In the latter case, the Wb2/Wb1 value (Wb1 (% by mass) being the content of the plate-like particle (b1) having an aspect ratio of 2 or more and Wb2 (% by mass) being the content of the needle-like particle (b2) having an aspect ratio of 2 or more) is preferably not smaller than 0.7 and not greater than 9 for enhancing thermal conductivity, more preferably not smaller than 1 and not greater than 8, further preferably 2 or more and not greater than 7. When the Wb2/Wb1 value is too small or too great, the probability at which the plate-like particle and the needle-like particle come into contact with each other may be reduced, decreasing the degree at which the thermal conductive rate of the film in a thickness direction is enhanced.

The Young's modulus of the polyester film needs to be 2 GPa or more. The Young's modulus herein is determined by measuring Young's moduli of the film as the orientation is changed by 10° in the plane of the film and calculating the average value of the greatest Young's modulus (Ea) and a Young's modulus (Eb) measured at an orientation orthogonal to that for the greatest Young's modulus. The Young's modulus is more preferably 2 GPa or more, further preferably not smaller than 3 GPa. The Young's modulus correlates with the orientation and the crystal state of the crystalline polyester (A). When the Young's modulus of the polyester film is lower than 2 GPa, it means that the orientation and the crystallinity of the crystalline polyester (A) are low and thereby heat resistance and dimensional stability are low. When the Young's modulus of the polyester film is 2 GPa or more, excellent heat resistance and excellent dimensional stability can be obtained.

A dynamic storage elastic modulus (E′) of the polyester film at 100° C. determined by dynamic viscoelasticity measurement (hereinafter, called DMA) at a frequency of 1 Hz is preferably not smaller than 5×10⁷ Pa, more preferably not smaller than 1×10⁸ Pa, further preferably not smaller than 5×10⁸ Pa. When the E′ value of the polyester film is too small, it means that the orientation and the crystallinity of the crystalline polyester (A) are low and thereby heat resistance and dimensional stability may be low. When the E′ value of the polyester film is not smaller than 5×10⁷ Pa, excellent heat resistance and excellent dimensional stability can be obtained.

With the content of the particle (B) in the P layer of the polyester film being defined as Wb (% by mass) and the porosity of the P layer of the polyester film being defined as V (% by volume), the V/Wb value needs to be not greater than 1. The porosity (V) (% by volume) herein is the proportion of the area of space in a cross-sectional area of the film in a cross-sectional SEM image of the P layer. The porosity is more preferably not greater than 0.8, further preferably not greater than 0.6, particularly preferably not greater than 0.5. When the V/Wb value is greater than 1, air (having a low thermal conductive rate) is present in a great proportion in the film, resulting in a decrease in thermal conductivity of the film. The lower limit of the V/Wb value is 0. When the V/Wb value of the polyester film is not greater than 1, excellent thermal conductivity can be obtained.

To obtain the polyester having the Young's modulus of 2 GPa or more, it is necessary that the polyester composition containing the P layer be stretched in at least one axial direction by the method described below. Typically, however, the crystalline polyester (A) is detached from the particle (B) at the interface therebetween in the stretching step and thereby voids are formed, resulting in the V/Wb value to be greater than 1. To make the Young's modulus of the polyester film be 2 GPa or more and to make the V/Wb value be not greater than 1, it is preferable that the surface of the particle (B) have a substituent reactive with the crystalline polyester (A) (hereinafter, the substituent is called reactive substituent (a)). The reactive substituent (a) herein refers to a substituent capable of reacting with and binding to a terminal carboxy group or a terminal hydroxy group of the polyester. Specific examples of the reactive substituent include substituents such as oxazoline group, epoxy group, carbodiimide group, isocyanate groups, and acid anhydride groups. A particularly preferable reactive substituent is an epoxy group, which has a particularly high reactivity with a polyester and forms a highly heat-resistant bond. Particularly, with this reactive substituent (a) being present on the surface of the particle (B), bonds are formed while the crystalline polyester (A) and the particle (B) are being kneaded together and thereby the resulting bonding at the interface becomes strong, making it possible to inhibit the crystalline polyester (A) from being detached from the particle (B) at the interface therebetween in the stretching step described below.

The amount of the reactive substituent (a) per unit surface area of the particle (B) in the polyester film is preferably not smaller than 0.2×10⁻⁶ mol/m² and not greater than 1.4×10⁻⁴ mol/m², more preferably not smaller than 1×10⁻⁵ mol/m² and not greater than 1×10⁻⁴ mol/m², further preferably not smaller than 1.3×10⁻⁵ mol/m² and not greater than 5×10⁻⁵ mol/m². When the amount of the reactive substituent is smaller than 0.2×10⁻⁶ mol/m², bonding between the crystalline polyester (A) and the particle (B) is not strong enough and thereby detachment at the interface during stretching becomes significant, resulting in a decrease in thermal conductivity. When the amount of the reactive substituent is greater than 1.4×10⁻⁴ mol/m², too many bonds are formed and thereby the stretchability decreases. When the amount of the reactive substituent (a) per unit surface area of the particle (B) in the polyester film is not smaller than 0.2×10⁻⁶ mol/m² and not greater than 1.4×10⁻⁴ mol/m², thermal conductivity and stretchability can be both obtained.

The amount of the reactive substituent (a) in the particle (B) can be determined by a known titration method. For example, the amount of epoxy groups was determined by the following method. The particle (B) was dispersed in water to prepare a solution, to which an HCl—CaCl₂ reagent was added, followed by reaction allowed to proceed at a certain temperature for a certain period of time. The reaction was then terminated by the addition of excess KOH (the amount of which was known), followed by back titration with an aqueous HCl solution and phenolphthalein as an indicator. The titration was performed separately on the particle (B) with surface treatment and on the particle (B) without surface treatment, and the results from the latter titration were used as a blank test to determine the amount of consumed HCl and then calculate the amount (mol) of epoxy groups in the sample solution. The surface area (m²) of the particle (B) was determined by the BET method described in JIS Z 8830 (2013). The amount (mol) of epoxy groups determined by the method described above was divided by the surface area (m²) determined by the BET method, and thus the amount (mol/m²) of the reactive substituent (a) was determined.

The particle (B) in the polyester film is preferably treated with a surface-treating agent containing the reactive substituent (a). Specific examples of the surface-treating agent include silane coupling agents containing an oxazoline group, an epoxy group, a carbodiimide group, an acid anhydride group, or an isocyanate group, titanium coupling agents, and aluminate-type coupling agents. Among these, silane coupling agents containing an epoxy group such as 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, and glycidoxyoctyltrimethoxysilane, silane coupling agents containing an isocyanate group such as 3-isocyanatopropyltriethoxysilane and 3-isocyanatopropyltrimethoxysilane, and silane coupling agents containing an acid anhydride group such as 3-trimethoxysilylpropylsuccinic anhydride, are suitably used, for example. Alkoxy oligomers containing the reactive substituent (a) are also suitably used. Also suitably used are resins produced by copolymerization of a monomer containing an epoxy group (such as glycidyl methacrylate) or a monomer containing an isocyanate group (such as 2-isocyanate ethyl methacrylate) with styrene, ethylene, propylene, or acrylic acid, for example; polycarbodiimide; resins containing an oxazoline group; and the like. Among these, from the viewpoint that the surface-treating agent can bind to both the crystalline polyester (A) and the particle (B) to form a strong interface, silane coupling agents containing an epoxy group such as 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, and glycidoxyoctyltrimethoxysilane, silane coupling agents containing an isocyanate group such as 3-isocyanatopropyltriethoxysilane and 3-isocyanatopropyltrimethoxysilane, silane coupling agents containing an acid anhydride group such as 3-trimethoxysilylpropylsuccinic anhydride, and alkoxy oligomers containing the reactive substituent (a) are particularly preferable. A mixture of two or more of the surface-treating agents containing the reactive substituent (a) and a mixture of the surface-treating agent containing the reactive substituent (a) and a surface-treating agent containing no reactive substituent are also preferably used.

The P layer of the polyester film is obtained by the production method described below using a resin composition containing the crystalline polyester (A) and at least one of the plate-like particle (b1) having an aspect ratio of 2 or more and the needle-like particle (b2) having an aspect ratio of 2 or more. The difference (ΔTcg) between the glass transition temperature (Tg) and a cold crystallization peak top temperature (Tcc) of the P layer is preferably not lower than 44° C. The glass transition temperature (Tg) and the cold crystallization peak top temperature (Tcc) herein are the glass transition temperature (Tg) and the cold crystallization peak top temperature (Tcc), respectively, measured while the temperature is being raised (at a temperature raising rate of 20° C./min). The glass transition temperature (Tg) and the cold crystallization peak top temperature (Tcc) are determined based on a differential scanning calorimetry chart for the 2nd RUN, obtained by the method described below in accordance with JIS K-7121 (1987). The difference between the Tg value and the Tcc value thus obtained is defined as ΔTcg. The ΔTcg value is more preferably not lower than 45° C. and not higher than 50° C. When the ΔTcg value is too low, stretching is difficult to perform and film-forming properties may be poor. When the ΔTcg value of the polyester film is not lower than 44° C., excellent film-forming properties can be obtained. Examples of preferable methods of making the ΔTcg value be not lower than 44° C. include increasing the IV value of the crystalline polyester (A) in the P layer. To increase the IV value of the crystalline polyester (A), it is particularly preferable that a chip-like composition obtained by mixing the crystalline polyester (A) and the particle (B) in the production method described below be subjected to solid-phase polymerization before film formation.

The polyester film may be either a monolayer film consisting of the P layer alone or a laminate film having a laminate of the P layer and an additional layer (hereinafter, the additional layer is sometimes abbreviated as P2 layer), and either of these cases is preferably used. In the laminate structure, the proportion of the P layer in the entire polyester film is preferably not lower than 40 volume %, more preferably not lower than 50 volume %, further preferably not lower than 70 volume %, particularly preferably not lower than 80 volume %, for the high heat resistance of the P layer to be exhibited. When the proportion of the P layer is lower than 40 volume %, the effect of the P layer to enhance heat resistance may not be exhibited. When the polyester film has the laminate structure and the proportion of the P layer is not lower than 40 volume %, the heat resistance of the polyester film can be high compared to that of conventional polyester films.

The thickness of the P layer of the polyester film is preferably not smaller than 5 μm and not greater than 500 μm, more preferably not smaller than 10 μm and not greater than 400 μm, further preferably not smaller than 20 μm and not greater than 300 μm. When the thickness is smaller than 5 μm, film-forming properties of the film are poor and film formation may be difficult to perform. When the thickness is greater than 500 μm, it may be difficult to process (for example, to cut or fold) the electrical insulation sheet having the film. When the thickness of the P layer of the polyester film is not smaller than 5 μm and not greater than 500 μm, film-forming properties and workability can be both obtained.

The thickness of the polyester film as a whole is preferably not smaller than 5 μm and not greater than 500 μm, more preferably not smaller than 10 μm and not greater than 400 μm, further preferably not smaller than 20 μm and not greater than 300 μm. When the thickness is smaller than 5 μm, film-forming properties of the film are poor and film formation may be difficult to perform. When the thickness is greater than 500 μm, it may be difficult to process (for example, to cut or fold) the electrical insulation sheet having the film. When the thickness of the polyester film as a whole is not smaller than 5 μm and not greater than 500 μm, film-forming properties and workability can be both obtained.

The elongation at break of the polyester film is preferably not lower than 10%, more preferably not lower than 20%, further preferably not lower than 30%. When the elongation at break of the polyester film is lower than 10%, the film readily breaks during film formation, during transfer in continuous processing, and during processing such as cutting. When the elongation at break of the polyester film is not lower than 10%, film-forming properties and workability can be both obtained. Examples of the method of making the elongation at break of the polyester film be not lower than 10% include using a preferable amount of the surface-treating agent in the production method described below and then, in particular, subjecting the chip-like composition obtained by mixing the crystalline polyester (A) and the particle (B) to solid-phase polymerization before film formation.

The thermal conductive rate of the polyester film in the film thickness direction is preferably not lower than 0.15 W/mK, more preferably not lower than 0.20 W/mK, further preferably not lower than 0.25 W/mK. With this thermal conductive rate, the polyester film can be suitably used as motor insulating materials (such as insulating sheets for wind power generation, sheets for hybrid motors, and sheets for motors in air conditioners), solar-cell back sheets, electrical insulating materials for use in electronic components (such as adhesive tape, flexible printed boards, and membrane switches for electronic components), and the like. Preferable examples of the method of increasing the thermal conductive rate in the film thickness direction include adopting the preferable formulation of raw materials described above and then, in particular, subjecting the chip-like composition obtained by mixing the crystalline polyester (A) and the particle (B) to solid-phase polymerization before film formation.

The surface specific resistance of the polyester film is preferably not lower than 10¹³ Ω/□. With this surface specific resistance, the polyester film can be suitably used as motor insulating materials (such as insulating sheets for wind power generation, sheets for hybrid motors, and sheets for motors in air conditioners), solar-cell back sheets, electrical insulating materials for use in electronic components (such as adhesive tape, flexible printed boards, and membrane switches for electronic components) and the like.

The P2 layer put on the polyester layer (P layer) of the polyester film may be any appropriate layer depending on the application, and examples include a function-imparting polyester layer, an antistatic layer, a layer for adhering to another material, an ultraviolet-resistant layer for imparting ultraviolet resistance, a flame-retardant layer for imparting flame retardancy, and a hard coating for enhancing impact resistance and abrasion resistance.

When the polyester film is evaluated by the UL94-VTM test method, the burned distance is preferably not greater than 125 mm, more preferably not greater than 115 mm, further preferably not greater than 105 mm, even further preferably not greater than 100 mm, particularly preferably not greater than 95 mm. When the burned distance of the polyester film evaluated by the UL94-VTM test method is not greater than 125 mm, a solar-cell back sheet or the like that has our polyester film can have enhanced safety.

Next, an example of the method of producing the polyester film is described below. The scope of this disclosure, however, is not limited to the method below.

The method of producing the polyester film has the following steps 1 to 3 in sequence:
(Step 1) A step of melt-kneading the crystalline polyester (A) with at least one of the plate-like particle (b1) having an aspect ratio of 2 or more and the needle-like particle (b2) having an aspect ratio of 2 or more; in particular, a step of melt-kneading the crystalline polyester (A) with at least one of the plate-like particle (b1) having an aspect ratio of 2 or more and having the substituent reactive with the crystalline polyester (A) (hereinafter, the substituent is called reactive substituent (a)) on the surface and the needle-like particle (b2) having an aspect ratio of 2 or more and having the reactive substituent (a) on the surface (hereinafter, the step is called melt-kneading step)
(Step 2) A step of melting the resulting resin composition containing the crystalline polyester (A) and the at least one of the plate-like particle (b1) having an aspect ratio of 2 or more and the needle-like particle (b2) having an aspect ratio of 2 or more and discharging the resin composition through a nozzle to obtain a film (hereinafter, the step is called melt-extruding step)
(Step 3) A step of biaxially stretching the resulting film (hereinafter, the step is called stretching step).

Next, the steps 1 to 3 and the like are described in detail.

### (Step 1)

The crystalline polyester (A) as a raw material used in the method of producing the polyester film is obtained by subjecting the dicarboxylic acid constituent and the diol constituent described above to esterification reaction or transesterification reaction for polycondensation and thus achieving an intrinsic viscosity of not lower than 0.4.

In the transesterification reaction, a known transesterification reaction catalyst such as magnesium acetate, calcium acetate, manganese acetate, cobalt acetate, or calcium acetate may be used, and antimony trioxide or other substances to serve as a polymerization catalyst may be added. When an alkali metal such as potassium hydroxide is added in an amount of several parts per million (ppm) in the esterification reaction, synthesis of diethylene glycol as a by-product is inhibited and, in addition, heat resistance and hydrolysis resistance are enhanced.

As the polycondensation reaction catalyst, a solution of germanium dioxide in ethylene glycol, antimony trioxide, a titanium alkoxide, or a titanium chelate compound may be used, for example.

Additional additives may also be added provided that the effects are not impaired, and examples of the additional additives include magnesium acetate to impart electrostatic application properties and calcium acetate as a co-catalyst. In addition, various particles to impart film smoothness may be added, or particles that contain a catalyst and are to be deposited inside the polyester film may be added.

In the method of producing the polyester film, when the particle (B) contains the reactive substituent (a), examples of the method of using the particle (B) include the following: a method i) in which the particle is dispersed in a solvent and to the resulting dispersion, while stirring, the surface-treating agent or a solution or a dispersion containing the surface-treating agent is added; and a method ii) in which to powders of the particle while being stirred, a solution or a dispersion containing the surface-treating agent is added. When the surface-treating agent is a resin-based one, a method iii) is also preferably employed in which the particle and the surface-treating agent are subjected to melt-kneading. Regarding the amount of the surface-treating agent added, the proportion (by mass) of the surface-treating agent is preferably not lower than 0.1 parts by mass and not higher than 5 parts by mass, more preferably not lower than 0.2 parts by mass and not higher than 3 parts by mass, further preferably not lower than 0.5 parts by mass and not higher than 1.5 parts by mass, relative to the content (Wb) of the particle (B) being defined as 100 parts by mass. When the proportion (by mass) of the surface-treating agent is lower than 0.1 parts by mass, bonding between the crystalline polyester (A) and the particle (B) is not strong enough and thereby detachment at the interface during stretching is significant, resulting in a decrease in thermal conductivity. When the proportion (by mass) of the surface-treating agent is higher than 5 parts by mass, too many bonds are formed and thereby the stretchability decreases.

Then, to add the plate-like particle (b1) or the needle-like particle (b2) to the crystalline polyester (A) obtained above, it is preferable that a combination of the crystalline polyester (A) and the plate-like particle (b1) or a combination of the crystalline polyester (A) and the needle-like particle (b2) be subjected to melt-kneading in advance in a vented twin screw kneader-extruder or a tandem extruder. To prevent the plate-like particle (b1) or the needle-like particle (b2) from breaking during melt-kneading, it is preferable that the plate-like particle (b1) or the needle-like particle (b2) be fed to the crystalline polyester (A) while the crystalline polyester is in a melted state and it is preferable that the feeding into the extruder be performed by side-feeding.

During melt-kneading performed for integrating the plate-like particle (b1) and/or the needle-like particle (b2) with the crystalline polyester (A), the crystalline polyester (A) receives strong heating and consequently degrades to a considerable degree. Considering this phenomenon, it is preferable from the viewpoint of reducing degradation of the crystalline polyester (A) and obtaining stretchability, mechanical properties, heat resistance and the like that a high-concentration master pellet be prepared (which is to be used in an amount greater than the content of the plate-like particle (b1) or the needle-like particle (b2) in the P layer) and the resulting high-concentration master pellet be mixed with the crystalline polyester (A) for dilution to make a predetermined amount of the plate-like particle (b1) or the needle-like particle (b2) be contained in the P layer.

The concentration of the particle in the high-concentration master pellet is preferably not lower than 20 mass % and not higher than 80 mass %, further preferably not lower than 25 mass % and not higher than 70 mass %, further more preferably not lower than 30 mass % and not higher than 60 mass %, particularly preferably not lower than 40 mass % and not higher than 60 mass %. When the concentration is lower than 20 mass %, the amount of the master pellet added to the P layer is great and thereby the content of a degraded crystalline polyester (A) in the P layer is great, potentially resulting in a decrease in stretchability, mechanical properties, heat resistance and the like. When the concentration is higher than 80 mass %, it may be difficult to prepare the master pellet or to uniformly mix the master pellet with the crystalline polyester (A).

Examples of the method of integrating both the plate-like particle (b1) and the needle-like particle (b2) with the crystalline polyester (A) include the following methods: a method in which a master pellet of the crystalline polyester (A) containing the plate-like particle (b1) and a master pellet of the crystalline polyester (A) containing the needle-like particle (b2) are separately prepared, and these master pellets are mixed with the crystalline polyester (A) for dilution to make the plate-like particle (b1) and the needle-like particle (b2) be contained in the P layer at a predetermined ratio; and a method in which a master pellet containing the plate-like particle (b1) and the needle-like particle (b2) at a predetermined ratio is prepared, and the resulting master pellet is mixed with the crystalline polyester (A) for dilution. Either of these methods may be employed.

The composition thus obtained in the step 1 is used in the step described next (Step 2). In this next step, it is particularly preferable to use the high-concentration master pellet (in which the content of the plate-like particle (b1) or the needle-like particle (b2) is greater than the content of the plate-like particle (b1) or the needle-like particle (b2) in the P layer) and then subject the resulting master pellet to solid-phase polymerization, from the viewpoints that the molecular weight can increase and the number of terminal carboxy groups can decrease. During the solid-phase polymerization reaction, it is preferable that the temperature during solid-phase polymerization be 30° C. lower than the melting point (Tm) of the polyester or lower, 60° C. lower than the melting point (Tm) of the polyester or higher, and the degree of vacuum be not higher than 0.3 Torr.

### (Step 2)

Described next is the step of forming a sheet of the composition obtained in the step 1 that contains the crystalline polyester (A) and the particle (B) consisting of the plate-like particle (b1) and the needle-like particle (b2).

When the polyester film has a monolayer film structure consisting of the P layer alone, sheet formation may be performed by heating and melting raw materials of the P layer in an extruder and then extruding the resultant through a nozzle onto a cold casting drum (the melt casting method); by dissolving raw materials of the P layer in a solvent and extruding the resulting solution through a nozzle onto a support such as a casting drum or an endless belt to form a film, followed by drying and removing the solvent of the film layer to form a sheet (the solution casting method); or other methods. Among these methods for sheet formation, from the viewpoint of high productivity, the melt casting method is preferable (hereinafter, the step of forming a sheet by the melt casting method is called melt-extruding step).

When the melt-extruding step is employed in the method of producing the polyester film, a dried composition containing the crystalline polyester (A) and at least one of the plate-like particle (b1) and the needle-like particle (b2) is subjected to melt-extrusion from an extruder through a nozzle to form a sheet, then the sheet is made electrostatically adhered to and cooled on a drum the surface of which has been cooled to a temperature of not lower than 10° C. and not higher than 60° C. for solidification to prepare a non-stretched sheet, and the resulting non-stretched sheet is biaxially stretched.

In melt-extrusion using an extruder, melting is performed in a nitrogen atmosphere. The duration of time after chip feeding into the extruder and before arrival at a nozzle for extrusion is preferably as short as possible. As a guide, the duration of time is preferably not longer than 30 minutes, more preferably not longer than 15 minutes, further preferably not longer than 5 minutes, for reducing degradation due to a decrease in molecular weight and for inhibiting an increase in the number of terminal carboxy groups.

### (Step 3)

The composition in a sheet form obtained in the step 2 is biaxially stretched at a temperature of not lower than the glass transition temperature (Tg). The method of biaxially stretching may be either sequential biaxial stretching in which stretching in a longitudinal direction and stretching in a width direction are performed separately, or simultaneous biaxial stretching in which stretching in the longitudinal direction and stretching in the width direction are performed simultaneously. Stretching conditions may be as follows, for example: 1) in simultaneous biaxial stretching, the stretching temperature is not lower than the glass transition temperature (Tg) of the polyester and not higher than Tg+15° C.; and 2) in sequential biaxial stretching, the stretching temperature for a first axial direction is not lower than the glass transition temperature (Tg) of the polyester and not higher than Tg+15° C. (more preferably not lower than Tg and not higher than Tg+10° C.) and the stretching temperature for a second axial direction is not lower than Tg+5° C. and not higher than Tg+25° C.

In either of simultaneous biaxial stretching and sequential biaxial stretching, the stretch factor in either the longitudinal direction or the width direction is not smaller than 1.5 and not greater than 4, more preferably 2 or more.0 and not greater than 3.5, further preferably 2 or more.0 and not greater than 3.0. The area stretch factor obtained from a combination of the stretch factor in the longitudinal direction and the stretch factor in the width direction is 2 or more and not greater than 16, more preferably not smaller than 4 and not greater than 13, further preferably not smaller than 4 and not greater than 9. When the area stretch factor is smaller than 2, the orientation of the crystalline polyester (A) in the resulting film is low and the mechanical strength and the heat resistance of the resulting film may be low. When the area stretch factor is greater than 14, breaking tends to occur during stretching and the porosity (V) of the resulting film tends to be great to cause a decrease in thermal conductivity.

To ensure that the resulting biaxially-stretched film has adequate crystal orientation and is thereby flat and dimensionally stable, heat treatment is performed at a temperature (Th) of not lower than the glass transition temperature (Tg) of the crystalline polyester (A) and lower than the melting point (Tm) of the crystalline polyester for a period of not shorter than 1 second and not longer than 30 seconds, followed by slow and uniform cooling to room temperature. Regarding the heat treatment temperature (Th) in the method of producing the polyester film, the difference (Tm-Th) between this heat treatment temperature and the melting point (Tm) of the polyester is not smaller than 20° C. and not greater than 90° C., more preferably not smaller than 25° C. and not greater than 70° C., further preferably not smaller than 30° C. and not greater than 60° C. During the heat treatment step, relaxing treatment to 3% to 12% in the width direction or the longitudinal direction may be performed as needed. Subsequently, corona discharge treatment and the like are performed as needed to enhance adhesion to other materials, followed by winding. Thus, the P layer can be obtained.

The method of producing the polyester film having a multilayer structure consisting of the P layer and the additional layer (P2 layer) is exemplified as follows. When each layer to be laminated is mainly made of a thermoplastic resin, two different materials are separately fed into two respective extruders, followed by melting and coextruding through respective nozzles onto a cold casting drum to form a sheet (coextrusion); a monolayer sheet is prepared, and a laminating material is fed into an extruder for melt-extrusion (by which the laminating material is extruded through a nozzle onto at least one side of the monolayer sheet) (melt lamination); the P layer and the P2 layer to be laminated are separately prepared, and then thermocompression bonding is performed using heated rolls and the like (heat lamination); bonding is performed using an adhesive agent (adhesion); the material or materials of the P2 layer are dissolved in a solvent and the resulting solution is applied to the P layer that has been prepared in advance (coating); or the like. Two or more of these techniques may be combined.

When the P2 layer is mainly composed of a material that is not a thermoplastic resin, the P layer and the P2 layer to be laminated may be separately prepared and then bonded to each other with an adhesive agent or the like interposed therebetween (adhesion). When that the P layer is made of a curing material, the curing material may be applied to the top side of the P layer and then cured by electromagnetic wave irradiation, heat treatment, or the like. Other preferable techniques may also be employed, and examples of these techniques include coextrusion, melt lamination, solution lamination, and heat lamination (all of these techniques being described above) as well as dry processes such as vapor deposition and sputtering and wet processes such as plating.

As the technique of forming the P2 layer from different materials by coating, either of the following techniques may be employed: in-line coating in which coating is performed during formation of the polyester film; and off-line coating in which coating is performed after formation of the polyester film. Among these techniques, in-line coating is more preferable because of the efficiency in coating that is performed simultaneously with formation of the polyester film and because of the excellent adhesion of the resulting layer to the polyester film. During coating, the surface of the polyester film is preferably subjected to corona treatment and the like.

The polyester film may be formed by the steps described above, and the resulting film has excellent thermal conductivity and excellent mechanical properties. The polyester film has excellent properties and thereby can be suitably used in applications where electrical insulating properties and thermal conductivity are both important, for example, in electrical insulating materials such as copper-clad laminates, solar-cell back sheets, adhesive tape, flexible printed boards, membrane switches, heating element sheets, and flat cables as well as capacitor materials, automobile materials, and building materials. Preferable among these applications are electrical insulating materials for motors and the like (such as insulating sheets for wind power generation, sheets for hybrid motors, and sheets for motors in air conditioners), solar-cell back sheet materials, and electrical insulating materials for use in electronic components (such as adhesive tape, flexible printed boards, and membrane switches for electronic components). Because the polyester film is excellent in thermal conductivity and mechanical properties compared to conventional polyester films, electrical insulation sheets (such as insulating sheets for wind power generation), solar-cell back sheets, and other products having the polyester film can have enhanced efficiency of power generation compared to the efficiency of conventional wind power generators and solar cells. When the polyester film is used in sheets for hybrid motors and sheets for motors in air conditioners, power consumption can be reduced. When the polyester film is used in adhesive tape, flexible printed boards, and membrane switches for electronic components, for example, not only low power consumption but also high-speed operation and enhanced reliability can be achieved.

### Method of Evaluation of Properties

### A. Analysis of Composition of Polyester

A polyester was hydrolyzed with an alkali and then gas chromatography or high-performance liquid chromatography was performed for analysis of each component. The peak area for each component was used to determine the composition ratio of the component. An example is shown below. A dicarboxylic acid constituent and other constituents were measured by high-performance liquid chromatography. The analysis can be suitably performed under known measurement conditions, and an example of the measurement conditions is shown below:
Apparatus: Shimadzu LC-10A
Column: YMC-Pack ODS-A 150×4.6 mm S-5 μm 120A
Column temperature: 40° C.
Flow rate: 1.2 ml/min
Detector: UV 240 nm.

Quantification of the diol constituent and other constituents was suitably performed by a known method based on gas chromatography, and an example of the measurement conditions is shown below:
Apparatus: Shimadzu 9A (manufactured by Shimadzu Corporation)
Column: SUPELCOWAX-10 capillary column 30 m
Column temperature: 140° C. to 250° C. (temperature raising rate: 5° C./min)
Flow rate: nitrogen 25 ml/min
Detector: FID.

### B. Intrinsic Viscosity (IV)

A polyester film (or a P layer of a laminate film) was dissolved in 100 ml of o-chlorophenol (polyester concentration in solution, C=1.2 g/ml), and the viscosity of the resulting solution at 25° C. was measured with an Ostwald viscometer. In the same manner, the viscosity of the solvent was also measured. The viscosity of the solution and the viscosity of the solvent thus measured as well as formula (1) were used to calculate [η], which was defined as the intrinsic viscosity (IV):

ηsp/C=[η]+K[η]²·C (1)

(in the formula, ηsp=(solution viscosity)/(solvent viscosity)−1, and K is the Huggins' constant (considered to be 0.343)). The measurement was performed after the particles (B) were separated.

### C. Glass Transition Temperature (Tg) of P Layer, Cold Crystallization Temperature (Tcc), Melting Point (Tm) of Crystalline Polyester (A), ΔHm Value (Amount of Heat for Crystal Melting)

A polyester film (or a P layer scraped off from a laminate film) was subjected to measurement in accordance with JIS K-7121 (1987) and JIS K-7122 (1987) performed by a differential scanning calorimeter “Robot DSC-RDC220” and to data analysis performed by a disc session “SSC/5200,” both devices being manufactured by Seiko Instruments & Electronics Ltd. The measurement was performed in the following manner.

### (1) 1st RUN Measurement

On a sample pan, 5 mg of a polyester film (or a P layer scraped off from a laminate film) as a sample was weighed. The resin was heated from 25° C. to 300° C. at a temperature raising rate of 20° C./min at a temperature raising rate of 20° C./minute and then maintained in that state for 5 minutes, followed by rapid cooling to a temperature of not higher than 25° C.

### (2) 2nd RUN

Immediately after the completion of the 1st RUN measurement, the resultant was reheated from room temperature to 300° C. at a temperature raising rate of 20° C./minute for measurement.

In a differential scanning calorimetry chart obtained for the 2nd RUN, a staircase-shape shift was observed indicating the occurrence of glass transition. Based on this staircase-shape shift, the glass transition temperature (Tg) of a crystalline polyester (A) was determined by a method described in JIS K-7121 (1987) “9.3 Determination of Glass Transition Temperature, (1) Midpoint Glass Transition Temperature (Tmg)” (a straight line was drawn a certain distance away from the baseline (and its extension) in the ordinate direction, then the point of intersection between the straight line and a curve of the staircase-shape shift indicating the occurrence of glass transition was specified, and then the reading of the temperature for the point of intersection was defined as the glass transition temperature). The temperature for the top of the cold crystallization peak was defined as the cold crystallization peak temperature (Tcc) of the crystalline polyester (A) in the P layer. The values (Tg and Tm) thus determined and formula (2) were used to determine the difference (ΔTcg) between the glass transition temperature (Tg) of the P layer and the cold crystallization peak top temperature (Tcc):

ΔTcg=Tcc−Tg (2).

Regarding thermal properties (the melting point (Tm) and the amount of heat for crystal melting (ΔHm)) of the crystalline polyester (A) as a raw material, measurement was performed by the same method as above, but this time using the crystalline polyester (A). The temperature for the top of the crystal melting peak in the differential scanning calorimetry chart obtained for the 2nd RUN was defined as the melting point (Tm), and the amount of heat for the crystal melting peak obtained according to “9. Determination of heat of transition” described in JIS K-7122 (1987) was defined as the amount of heat for crystal melting (ΔHm).

### D. Young's Modulus, Elongation at Break

The elongation at break of the polyester film was determined by pulling a fragment of the polyester film having a size of 1 cm×20 cm at a chuck-to-chuck distance of 5 cm and a strain rate of 300 mm/min according to ASTM-D882(1997). From the resulting load-strain curve, the Young's modulus was determined. The measurement was repeated five times for one sample, and the average value was used.

First, the direction (direction a) at which the Young's modulus was at its maximum was determined as follows. An arbitrary direction was designated as 0°, and the Young's modulus was measured every 10° from −90° to 90° in the plane of the film all in the same manner. In this way, the direction (direction a) at which the Young's modulus was at its maximum was determined. Thus, the Young's modulus (Ea) was determined. Subsequently, the Young's modulus (Eb) at a direction (direction b) that was orthogonal to the direction a in the same plane was determined. The average value of these values (Ea and Eb) was defined as the Young's modulus. The elongation at break was defined as the average value of the elongation at break in the direction a and the elongation at break in the direction b.

### E. Porosity (V)

The porosity was determined by the following procedures (A1) to (A5). Measurement was performed on ten randomly selected cross-sections in the film, and the arithmetic mean was defined as the porosity (V) (% by volume) of the P layer.
(A1) The film was cut with a microtome vertically to the direction of the plane of the film, with the cross section not crushed in the thickness direction.
(A2) The cross section was observed with a scanning electron microscope, and an image under 3000-time magnification was obtained. The observation was performed for a randomly selected position in the P layer in the image provided that the direction from the lower end to the upper end of the image was parallel to the thickness direction of the film and the direction from the left end to the right end of the image was parallel to the direction of the plane of the film.
(A3) The area of the P layer in the image obtained in (A2) was measured and defined as A.
(A4) The area of all the spaces in the P layer in the image was measured and defined as B. The measurement target included not only air bubbles that were entirely included within the image but also air bubbles that were only partially included within the image.
(A5) The value B was divided by the value A, and the resulting value (B/A) was multiplied by 100. This value thus obtained was defined as the proportion of space areas in the P layer, which was used as the porosity (V) (% by volume).

### F. Content (Wb1) of Plate-Like Particle (b1) and Content (Wb2) of Needle-Like Particle (b2) in P Layer

The content (Wb1) of the plate-like particle (b1) and the content (Wb2) of the needle-like particle (b2) in the P layer were determined in the following procedures (B1) to (B13) by using a polyester film (or a P layer scraped off from a laminate film).
(B1) The mass (w1) of the polyester film (or the P layer scraped off from a laminate film) was measured.
(B2) The polyester film (or the P layer scraped off from a laminate film) was dissolved in hexafluoro-2-isopropanol and then centrifugation was performed to fractionate insoluble components, which were particles.
(B3) The resulting particles were rinsed in hexafluoro-2-isopropanol, followed by centrifugation. The rinsing was repeated until a rinsing liquid yielded after centrifugation did not become cloudy by addition of ethanol.
(B4) The rinsing liquid in (B3) was heated and distilled, followed by air drying for 24 hours and then vacuum drying at a temperature of 60° C. for 5 hours. Thus, particles were obtained. The mass (w2) of the resulting particles was determined, and then formula (3) was used to calculate the total content (Wb) (% by mass) of the particles:

Wb=(w2/w1)×100 (3).
(B5) The particles obtained in (B4) were immobilized on an observation platform equipped with a 3D gauge for dimension measurement. Then, an image of the particles under 3000-time magnification was obtained using a scanning electron microscope.
(B6) Then, a single primary particle randomly selected from the image was subjected to image analysis on 3D measurement software. Thus, a circumscribing rectangular parallelepiped was drawn.
(B7) The size of the particle was measured with the longest side of the circumscribing rectangular parallelepiped being regarded as equivalent to the length (l) of the particle, the shortest side being regarded as equivalent to the thickness (t) of the particle, and the remaining side being regarded as equivalent to the width (b) of the particle. Thus, the shape of the particle was uniquely defined by a combination of these three values (l, t, b).
(B8) The procedures of (B6) and (B7) were performed for 500 randomly selected primary particles. Each of the three values, namely, the length (l), the thickness (t), and the width (b), was plotted to obtain a distribution curve. The abscissa of the distribution curve indicates the sizes (μm) of the particles, and the ordinate indicates the number (number) of the particles.
(B9) The position of the peak of each of the three distribution curves was identified, and the reading on the abscissa for the position was defined as the average length (lp), the average thickness (tp), or the average width (bp) of the particles. If a single distribution curve had two or more peaks, it indicates that multiple types of particles different in shape coexisted. In such cases, the following procedures were performed: all possible particle shapes (combinations of lp, tp, and bp) possible from the peak positions were listed; each of the 500 primary particles subjected to size measurement was assigned to the most appropriate and closest particle shape among these possible particle shapes; particles assigned to the same particle shape were counted; and it was regarded that a particle shape to which five or more particles were assigned was actually present.
(B10) Among the particles assigned to different particle shapes in (B9), a particle having a ratio (l/b) of the length (l) to the width (b) of not lower than 1 and not higher than 2 was defined as a plate-like particle, and a particle having the ratio (l/b) of higher than 2 was defined as a needle-like particle.
(B11) Among the 500 particles subjected to size measurement in (B8), the plate-like particle defined in (B10) was subjected to calculation of the virtual volume (μm³) by formula l×t×b to calculate the sum of the virtual volumes (Vv1) (μm³). The chemical composition of the plate-like particle was determined by composition analysis by SEM/EDX (scanning electron microscope/energy dispersive X-ray spectroscopy). Based on the resulting chemical composition, a typical density (D1) (g/μm³) of the particles was obtained from a known document (such as Filler Handbook (edited by The Society of Rubber Science and Technology, Japan, 1987)) by citation. Using formula D1×Vv1, the mass (Wv1) of the plate-like particle was determined.
(B12) In the same manner as in (B11), the needle-like particle defined in (B10) among the 500 particles subjected to size measurement in (B8) was subjected to determination of the apparent mass (Wv2) (g).
(B13) Formulae (4) and (5) were used to calculate the content (Wb1) (% by mass) of the plate-like particle (b1) in the P layer and the content (Wb2) (% by mass) of the needle-like particle (b2) in the P layer:

Wb1=Wb×(Wv1/(Wv1+Wv2)) (4)

Wb2=Wb×(Wv2/(Wv2+Wv1)) (5).

### G. Thermal Conductive Rate in Film Thickness Direction

To a polyester film, a laser absorbing spray (Black Guard Spray FC-153 manufactured by Finechemical Japan Co., Ltd.) was applied. The resultant was dried and then cut into a 10-mm-square fragment. The diffusivity of heat (α) (m²/s) of the fragment in the film thickness direction was measured at a temperature of 25° C. with a Xe flash analyzer, LFA447 Nanoflash manufactured by NETZSCH. The measurement was repeated four times, and the average value was defined as the diffusivity of heat. Then, formula (6) was used to determine the thermal conductive rate:

Thermal conductive rate (W/mK)=α(m²/s)×specific heat (J/kg·K)×density (kg/m³) (6).

The specific heat was determined using a polyester film according to JIS K-7123 (1987). The density was determined as follows: the film was cut into a fragment having a size of 30 mm×40 mm; the density of the fragment was measured with an electronic densimeter (SD-120L manufactured by Mirage Trading Co., Ltd.) in an atmosphere at room temperature (23° C.) and a relative humidity of 65%; and the measurement was repeated three times and the average value was used.

### H. Heat Resistance

A rectangular fragment having a size of 1 cm×20 cm was cut out in a direction parallel to the direction a, followed by heat treatment in a hot-air oven at 150° C. for 30 minutes and then cooling. According to the procedures in the section D described above, elongation at break was determined. The resulting value of elongation at break and the value of elongation at break (elongation at break before heat treatment) in the direction a obtained in the section D as well as formula (7) were used to calculate elongation retention:

Elongation retention (%)=(elongation at break before heat treatment)/(elongation at break after heat treatment)×100 (7).

The resulting value of elongation retention was used in the following evaluation. Samples having values within the range A are suitable for practical use.
A: Elongation retention of not lower than 50%
D: Elongation retention of lower than 50%

### I. Surface Specific Resistance

The surface specific resistance of a film was measured with a digital ultrahigh-resistance micro ammeter R8340 (manufactured by Advantest Corporation). The measurement was performed for each side of the film, at any ten positions on each side. The average of the ten readings for each side was calculated, and the smaller average value was defined as the surface specific resistance. Before the measurement, the sample had been left overnight in a room at 23° C. and 65% Rh. The resulting value was used in the following evaluation. Samples having values within the range A are suitable for practical use.
A: Surface specific resistance of not lower than 10¹³ Ω/□
D: Surface specific resistance of lower than 10¹³ Ω/□

### J. Dynamic Storage Elastic Modulus

The dynamic storage elastic modulus (E′) was determined according to JIS-K7244 (1999) with a dynamic viscoelasticity measurement device DMS6100 (manufactured by Seiko Instruments Inc.). The temperature dependence of viscoelasticity properties of each film was evaluated under conditions of a pulling mode, an operation frequency of 1 Hz, a chuck-to-chuck distance of 20 mm, and a temperature raising rate of 2° C./min. The results of the evaluation were used to determine the dynamic storage elastic modulus (E′) at 100° C.

### EXAMPLES

Hereinafter, our sheets, tapes, films and methods will be described by examples. The scope of this disclosure, however, is not limited to these examples.

### Raw Materials

### Crystalline Polyester (A):

PET-1: Using dimethyl terephthalate as an acid component and ethylene glycol as a diol component, germanium oxide (polymerization catalyst) was added 300 ppm (in terms of germanium atoms) to a polyester pellet to be obtained, followed by polycondensation reaction. Thus, a poly(ethylene terephthalate) pellet having an intrinsic viscosity of 0.64 was obtained. The resulting resin had a glass transition temperature (Tg) of 83° C., a melting point (Tm) of 255° C., and an amount of heat for crystal melting of 37 J/g.
PET-2: Using dimethyl terephthalate as an acid component and ethylene glycol as a diol component, germanium oxide (polymerization catalyst) was added 300 ppm (in terms of germanium atoms) to a polyester pellet to be obtained, followed by polycondensation reaction. Thus, a poly(ethylene terephthalate) pellet having an intrinsic viscosity of 0.54 was obtained. The resulting poly(ethylene terephthalate) was dried at 160° C. for 6 hours for crystallization, followed by solid-phase polymerization at 220° C. and a degree of vacuum of 0.3 Torr for 5 hours. Thus, poly(ethylene terephthalate) having an intrinsic viscosity of 0.70 was obtained. The resulting resin had a glass transition temperature (Tg) of 83° C., a melting point (Tm) of 255° C., and an amount of heat for crystal melting of 35 J/g.
PET-3: Poly(ethylene terephthalate) having an intrinsic viscosity of 0.80 was obtained in the same manner as in the section of PET-2 except that the duration of the solid-phase polymerization was 8 hours. The resulting resin had a glass transition temperature (Tg) of 83° C., a melting point (Tm) of 255° C., and an amount of heat for crystal melting of 36 J/g.

### Particle

Wollastonite-1: FPW#400 (manufactured by Kinsei Matec Co., Ltd.) was used, which was a needle-like particle having a length of 8.0 μm and an aspect ratio of 4.
Wollastonite-2: NYAD M1250 (manufactured by Tomoe Engineering Co., Ltd.) was used, which was a needle-like particle having a length of 12 μm and an aspect ratio of 3.
Needle-like titanium oxide: FTL-100 (manufactured by Ishihara Sangyo Kaisha, Ltd.) was used, which was a needle-like particle having a length of 1.7 μm and an aspect ratio of 13.
Boron nitride: SP3-7 (manufactured by Denki Kagaku Kogyo Kabushiki Kaisha) was used, which was a plate-like particle having a length of 2.0 μm and an aspect ratio of 19.
Talc: GH-7 (manufactured by Hayashi Kasei Co., Ltd.) was used, which was a plate-like particle having a length of 5.8 μm and an aspect ratio of 10.
Alumina: A4-42-2 (manufactured by Showa Denko K.K.) was used, which had a length of 5 μm, an amorphous shape, and an aspect ratio of 1.

The length (aspect ratio) of each particle contained in a polyester film (or a P layer scraped off from a laminate film) was determined by performing the following treatments (C1) to (C3) and then performing the following procedures (C4) to (C8). The length (aspect ratio) of each particle before added to the resin was determined by the procedures (C4) to (C8).
(C1) The polyester film (or the P layer scraped off from a laminate film) was dissolved in hexafluoro-2-isopropanol, and centrifugation was performed to fractionate insoluble components, which were particles.
(C2) The resulting particles were rinsed in hexafluoro-2-isopropanol, followed by centrifugation. The rinsing was repeated until a rinsing liquid yielded after centrifugation did not become cloudy by addition of ethanol.
(C3) The rinsing liquid in (C2) was heated and distilled, followed by air drying for 24 hours and then vacuum drying at a temperature of 60° C. for 5 hours. Thus, particles were obtained, which were to be subjected to observation.
(C4) The particles were immobilized on an observation platform equipped with a 3D gauge for dimension measurement. Then, an image of the particles under 3000-time magnification was obtained using a scanning electron microscope.
(C5) Then, a single primary particle randomly selected from the image was subjected to image analysis on 3D measurement software. Thus, a circumscribing rectangular parallelepiped was drawn.
(C6) The size of the particle was measured with the longest side of the circumscribing rectangular parallelepiped being regarded as equivalent to the length (l) of the particle, the shortest side being regarded as equivalent to the thickness (t) of the particle, and the remaining side being regarded as equivalent to the width (b) of the particle. Thus, the shape of the particle was uniquely defined by a combination of these three values (l, t, b).
(C7) The procedures of (C5) and (C6) were performed for 500 randomly selected primary particles. Each of the three values, namely, the length (l), the thickness (t), and the width (b), was plotted to obtain a distribution curve. The abscissa of the distribution curve indicates the sizes (μm) of the particles, and the ordinate indicates the number (number) of the particles.
(C8) The position of the peak of each of the three distribution curves was identified, and the reading on the abscissa for the position was defined as the average length (lp), the average thickness (tp), or the average width (bp) of the particles. The ratio (lp/tp) of the average length to the average thickness was defined as the aspect ratio of the particles. If a single distribution curve had two or more peaks, it indicates that multiple types of particles different in shape coexisted. In such cases, the following procedures were performed: all possible particle shapes (combinations of lp, tp, and bp) possible from the peak positions were listed; each of the 500 primary particles subjected to size measurement was assigned to the most appropriate and closest particle shape among these possible particle shapes; particles assigned to the same particle shape were counted; it was regarded that a particle shape to which five or more particles were assigned was actually present; and the aspect ratio (lp/tp) of such a particle was calculated.
   Surface-treating agent
SC-1: Epoxy-group-containing silane coupling agent KBM-403 (manufactured by Shin-Etsu Chemical Co., Ltd.; compound name, 3-glycidoxypropyltrimethoxysilane; molecular weight, 236.3)
SC-2: Epoxy-group-containing silane coupling agent KBM-4803 (manufactured by Shin-Etsu Chemical Co., Ltd.; compound name, glycidoxyoctyltrimethoxysilane; molecular weight, 306.4)

### Reference Example 1-1

Wollastonite-1 was placed in a Henschel mixer. To the wollastonite-1 while stirring, a silane coupling agent was sprayed at a rate of 0.1 mass % (2.8×10⁻⁶ mol/m² in terms of epoxy groups) relative to the total amount of the needle-like particle (b2) and the silane coupling agent being 100 mass %. After 2 hours of heating and stirring at 70° C., the needle-like particle (b2) having an epoxy group on the surface of the needle-like particle (b2) was taken out.

A vented twin screw co-rotating kneader-extruder (manufactured by the Japan Steel Works, Ltd.; screw diameter, 30 mm; (screw length)/(screw diameter)=45.5) equipped with one or more side feeding ports and a single kneading-paddle kneading portion was heated to 265° C., and then 70 parts by mass of PET-1 as the crystalline polyester (A) was fed thereinto through a main feeding port and 30 parts by mass of the needle-like particle (b2) was fed thereinto through a side feeding port, followed by melt-kneading. The resulting melt-kneaded product was discharged in a form of a strand and cooled in water at a temperature of 25° C. Immediately after the cooling, the resulting strand was cut. Thus, a master pellet (MB-1-1) containing 30 mass % of the needle-like particle (b2) was prepared. Physical properties of the resulting master pellet are shown in Table 1.

### Reference Examples 1-2 to 1-4, 2-1 to 2-4, 3-1 to 3-4

Master pellets (MB-1-2 to 1-4, 2-1 to 2-4, and 3-1 to 3-4) containing 30 mass % of the plate-like particle (b1) or the needle-like particle (b2) were prepared in the same manner as in Reference Example 1-1 except that the type of the particle, the type of the surface-treating agent, and the amount subjected to treatment were as specified in Table 1. Physical properties of the resulting master pellets are shown in Table 1.

### Reference Example 1-5

A master pellet (MB-1-5) containing 30 mass % of the needle-like particle (b2) was prepared in the same manner as in Reference Example 1-1 except that the particle received no surface treatment. Physical properties of the resulting master pellet are shown in Table 1.

### Reference Example 3-5

A master pellet (MB-3-5) containing 30 mass % of the particle was prepared in the same manner as in Reference Example 1-1 except that the particle was alumina and the amount subjected to treatment was as specified in Table 1. Physical properties of the resulting master pellet are shown in Table 1.

### Reference Example 4-1

The master pellet (MB-1-3) prepared in Reference Example 1-3 was dried at 160° C. for 6 hours for crystallization and then subjected to solid-phase polymerization at 220° C. and a degree of vacuum of 0.3 Torr for 6 hours. Thus, a master pellet (MB-4-1) was prepared. Physical properties of the resulting master pellet are shown in Table 1.

### Reference Example 4-2

The master pellet (MB-1-3) prepared in Reference Example 1-3 was dried at 160° C. for 6 hours for crystallization and then subjected to solid-phase polymerization at 220° C. and a degree of vacuum of 0.3 Torr for 12 hours. Thus, a master pellet (MB-4-2) was prepared. Physical properties of the resulting master pellet are shown in Table 1.

### Example 1

A mixture of 66.7 parts by mass of the master pellet (MB-1-1) prepared in Reference Example 1-1 and 33.3 parts by mass of PET-1 was subjected to vacuum drying at a temperature of 180° C. for 3 hours and then fed into an extruder for melting in a nitrogen atmosphere at a temperature of 280° C., followed by transfer to a T-die nozzle. The extruder was equipped with an 80-μm sintered filter. Through the T-die nozzle, the resulting mixture was extruded into a sheet form. The resulting melted monolayer sheet was electrostatically adhered to and cooled on a drum the surface of which had been maintained at a temperature of 25° C., for solidification. Thus, a non-stretched monolayer film was obtained.

The resulting non-stretched monolayer film was preheated using rolls that were heated to a temperature of 85° C., and then stretched using a roll heated to a temperature of 90° C. to a stretch factor of 2.5 in the longitudinal direction (length direction), followed by cooling using rolls at a temperature of 25° C. Thus, a uniaxially-stretched film was obtained. The resulting uniaxially-stretched film was held at both ends with clips and transferred to a preheating zone at a temperature of 80° C. located in a tenter, immediately continuously followed by stretching in a heating zone at a temperature of 90° C. to a stretch factor of 2.5 in a direction (width direction) orthogonal to the longitudinal direction. Subsequently, heat treatment was performed in a heat treatment zone 1 in the tenter at a temperature of 220° C. for 20 seconds, then in a heat treatment zone 2 at a temperature of 150° C., and then in a heat treatment zone 3 at a temperature of 100° C. After the heat treatment in the heat treatment zone 1 and before the heat treatment in the heat treatment zone 2, 4% relaxing treatment was performed. Subsequently, slow and uniform cooling was performed, followed by winding. Thus, a biaxially-stretched film having a thickness of 50 μm was obtained.

Properties of the resulting film were evaluated, and the results are shown in Table 2. The results have proven that the film was excellent in thermal conductivity, mechanical properties, and heat resistance.

### Examples 2 to 20

A polyester film having a thickness of 50 μm was obtained in the same manner as in Example 1 except that the type and the amount of the master pellet and the type and the amount of the crystalline polyester (A) were as specified in Table 2. Properties of the resulting film were evaluated, and the results are shown in Table 2. The results have proven that the film was excellent in thermal conductivity, mechanical properties, and heat resistance. The polyester films in Examples 4 to 7, 9 to 11, and 16 to 18, in particular, had excellent thermal conductivity compared to the polyester film in Example 1. Among these, each of the polyester films in Examples 11 and 16 had particularly excellent thermal conductivity.

### Example 21

A mixture of 51.7 parts by mass of the master pellet (MB-1-2) prepared in Reference Example 1-2, 15.0 parts by mass of the master pellet (MB-3-4) prepared in Reference Example 3-4, and 33.3 parts by mass of PET-1 was subjected to vacuum drying at a temperature of 180° C. for 3 hours and then fed into an extruder for melting in a nitrogen atmosphere at a temperature of 280° C., followed by transfer to a T-die nozzle. The rest of the procedures was performed in the same manner as in Example 1, and thus a polyester film having a thickness of 50 μm was obtained. Properties of the resulting film were evaluated, and the results are shown in Table 2. The results have proven that the film was excellent in thermal conductivity, mechanical properties, and heat resistance. It has been proven that the film obtained in Example 21 was excellent in thermal conductivity compared to the film obtained in Example 19 or 20.

### Examples 22 to 28

A polyester film having a thickness of 50 μm was obtained in the same manner as in Example 21 except that the master pellet was used in the amount specified in Table 2. Properties of the resulting film were evaluated, and the results are shown in Table 2. The results have proven that the film was excellent in thermal conductivity, mechanical properties, and heat resistance. The polyester films in Examples 22 to 27, in particular, had excellent thermal conductivity compared to the polyester film in Example 28. Among these, each of the polyester films in Examples 22 to 25 had a particularly excellent thermal conductive rate.

### Comparative Examples 1 to 8

A polyester film having a thickness of 50 μm was obtained in the same manner as in Example 1 except that the type and the amount of the master pellet, the type and the amount of the crystalline polyester (A), and the stretching conditions were as specified in Table 2. Properties of the resulting film were evaluated, and the results are shown in Table 2. The polyester films in Comparative Examples 1 to 3 and 5 to 8 had low thermal-conductivity and the polyester film in Comparative Example 4 had low heat-resistance compared to the polyester film in Example 1.

In the tables, exponents are abbreviated. For example, the expression 1.0E+05 means 1.0×10⁻⁵.

TABLE 1

| | | | | Ref. Ex. 1-1 | Ref. Ex. 1-2 | Ref. Ex. 1-3 | Ref. Ex. 1-4 | Ref. Ex. 1-5 |
|---|---|---|---|---|---|---|---|---|
| | | | | MB-1-1 | MB-1-2 | MB-1-3 | MB-1-4 | MB-1-5 |
| Crystalline polyester | | Type | — | PET | PET | PET | PET | PET |
| (A) | | Amount | Parts by mass | 70 | 70 | 70 | 70 | 70 |
| Particle | Type | | — | Wollastonite-1 | Wollastonite-1 | Wollastonite-1 | Wollastonite-1 | Wollastonite-1 |
| | Average length (l) | | μm | 8.0 | 8.0 | 8.0 | 8.0 | 8.0 |
| | Aspect ratio (l/t) | | — | 4 | 4 | 4 | 4 | 4 |
| | l/b | | — | 4 | 4 | 4 | 4 | 4 |
| | Surface | Type | — | SC-1 | SC-1 | SC-1 | SC-1 | — |
| | treatment | Amount treated | wt % | 0.1 | 0.5 | 1 | 2 | — |

| | | | | | | |
|---|---|---|---|---|---|---|
| Amount of reactive | ×10⁻⁶ mol/m² | 2.8 | 13.9 | 27.9 | 56.4 | 0 |
| substituent (a) | | | | | | |
| Amount | Parts by mass | 30 | 30 | 30 | 30 | 30 |

| | | | | | | | |
|---|---|---|---|---|---|---|---|
| Solid-phase | Time | hr | — | — | — | — | — |
| polymerization | | | | | | | |

| | | | | | | |
|---|---|---|---|---|---|---|
| IV | — | 0.60 | 0.60 | 0.62 | 0.63 | 0.58 |

| | | | | Ref. Ex. 2-1 | Ref. Ex. 2-2 | Ref. Ex. 2-3 | Ref. Ex. 2-4 |
|---|---|---|---|---|---|---|---|
| | | | | MB-2-1 | MB-2-2 | MB-2-3 | MB-2-4 |
| Crystalline polyester | | Type | — | PET | PET | PET | PET |
| (A) | | Amount | Parts by mass | 70 | 70 | 70 | 70 |
| Particle | Type | | — | Wollastonite-1 | Wollastonite-1 | Wollastonite-1 | Wollastonite-1 |
| | Average length (l) | | μm | 8.0 | 8.0 | 8.0 | 8.0 |
| | Aspect ratio (l/t) | | — | 4 | 4 | 4 | 4 |
| | l/b | | — | 4 | 4 | 4 | 4 |
| | Surface | Type | — | SC-2 | SC-2 | SC-2 | SC-2 |
| | treatment | Amount treated | wt % | 0.1 | 0.5 | 1 | 2 |

| | | | | | |
|---|---|---|---|---|---|
| Amount of reactive | ×10⁻⁶ mol/m² | 2.1 | 10.7 | 21.5 | 43.5 |
| substituent (a) | | | | | |
| Amount | Parts by mass | 30 | 30 | 30 | 30 |

| | | | | | | |
|---|---|---|---|---|---|---|
| Solid-phase | Time | hr | — | — | — | — |
| polymerization | | | | | | |

| | | | | | |
|---|---|---|---|---|---|
| IV | — | 0.60 | 0.60 | 0.62 | 0.63 |

| | | | | | | | | | Ref. Ex. | Ref. Ex. |
|---|---|---|---|---|---|---|---|---|---|---|
| | | | | Ref. Ex. 3-1 | Ref. Ex. 3-2 | Ref. Ex. 3-3 | Ref. Ex. 3-4 | Ref. Ex. 3-5 | 4-1 | 4-2 |
| | | | | MB-3-1 | MB-3-2 | MB-3-3 | MB-3-4 | MB-3-5 | MB-4-1 | MB-4-2 |
| Crystalline polyester | | Type | — | PET | PET | PET | PET | PET | PET | PET |
| (A) | | Amount | Parts by mass | 70 | 70 | 70 | 70 | 70 | 70 | 70 |
| Particle | Type | | — | Talc | Wollastonite-2 | Needle-like | Boron nitride | Alumina | Wollas- | Wollas- |
| | | | | | | titanium oxide | | | tonite-1 | tonite-1 |
| | Average length (l) | | μm | 5.8 | 12.0 | 1.7 | 2.0 | 5.0 | 8.0 | 8.0 |
| | Aspect ratio (l/t) | | — | 10 | 3 | 13 | 19 | 1 | 4 | 4 |
| | l/b | | — | 1.2 | 3 | 12 | 18 | 1 | 4 | 4 |
| | Surface | Type | — | SC-1 | SC-1 | SC-1 | SC-1 | SC-1 | SC-1 | SC-1 |
| | treatment | Amount treated | wt % | 1 | 0.5 | 0.5 | 0.5 | 0.5 | 1 | 1 |

| | | | | | | | | |
|---|---|---|---|---|---|---|---|---|
| Amount of reactive | ×10⁻⁶ mol/m² | 27.9 | 14.5 | 25.4 | 22.6 | 14.0 | 27.9 | 27.9 |
| substituent (a) | | | | | | | | |
| Amount | Parts by mass | 30 | 30 | 30 | 30 | 30 | 30 | 30 |

| | | | | | | | | | |
|---|---|---|---|---|---|---|---|---|---|
| Solid-phase | Time | hr | — | — | — | — | — | 6 | 12 |
| polymerization | | | | | | | | | |

| | | | | | | | | |
|---|---|---|---|---|---|---|---|---|
| IV | — | 0.62 | 0.60 | 0.61 | 0.61 | 0.58 | 0.76 | 0.87 |

TABLE 2

| | | | | | Ex. 1 | Ex. 2 | Ex. 3 | Ex. 4 | Ex. 5 | Ex. 6 | Ex. 7 |
|---|---|---|---|---|---|---|---|---|---|---|---|
| Production | Raw material | PET | Type | — | PET-1 | PET-1 | PET-1 | PET-1 | PET-1 | PET-1 | PET-1 |
| conditions | | | Amount | Parts by mass | 66.7 | 66.7 | 66.7 | 66.7 | 50.0 | 33.3 | 16.7 |
| | | Master pellet | Type | — | MB-1-1 | MB-1-2 | MB-1-3 | MB-1-4 | MB-1-3 | MB-1-3 | MB-1-3 |
| | | (1) | Amount | Parts by mass | 33.3 | 33.3 | 33.3 | 33.3 | 50.0 | 66.7 | 83.3 |
| | | Master pellet | Type | — | — | — | — | — | — | — | — |
| | | (2) | Amount | Parts by mass | — | — | — | — | — | — | — |
| | Stretching | Vertical | Temperature | ° C. | 90 | 90 | 90 | 90 | 90 | 90 | 90 |
| | | stretching | Stretching | Times | 2.5 | 2.5 | 2.5 | 2.5 | 2.5 | 2.5 | 2.5 |
| | | | factor | | | | | | | | |
| | | Transverse | Temperature | ° C. | 90 | 90 | 90 | 90 | 90 | 90 | 90 |
| | | stretching | Stretching | Times | 2.5 | 2.5 | 2.5 | 2.5 | 2.5 | 2.5 | 2.5 |
| | | | factor | | | | | | | | |

| | | | | | | | | | |
|---|---|---|---|---|---|---|---|---|---|
| Physical | Aspect ratio of plate-shaped particle (b1) | — | — | — | — | — | — | — | — |
| properties | Content (Wb1) of plate-shaped particle (b1) | Mass % | — | — | — | — | — | — | — |
| of film | Aspect ratio of needle-shaped particle (b2) | — | 4 | 4 | 4 | 4 | 4 | 4 | 4 |
| | Content (Wb2) of needle-shaped particle (b2) | Mass % | 10 | 10 | 10 | 10 | 15 | 20 | 25 |
| | Wb | Mass % | 10 | 10 | 10 | 10 | 15 | 20 | 25 |
| | V | Volume % | 6.2 | 4.2 | 3.1 | 2.1 | 5.5 | 8 | 12 |
| | V/Wb | — | 0.62 | 0.42 | 0.31 | 0.21 | 0.37 | 0.40 | 0.48 |
| | Wb2/Wb1 | — | — | — | — | — | — | — | — |
| | IV | — | 0.59 | 0.59 | 0.60 | 0.60 | 0.58 | 0.55 | 0.53 |
| | ΔTcg | ° C. | 43.5 | 43.6 | 43.7 | 43.7 | 43.1 | 42.8 | 42.3 |
| | Young's modulus | GPa | 4.0 | 4.0 | 4.0 | 3.9 | 4.3 | 4.5 | 4.6 |
| | Elongation at break | % | 75 | 85 | 85 | 65 | 50 | 20 | 20 |
| | Thermal conductive rate | W/mK | 0.16 | 0.17 | 0.18 | 0.20 | 0.20 | 0.21 | 0.22 |
| | Dynamic storage elastic modulus | Pa | 2.2E+09 | 2.2E+09 | 2.2E+09 | 2.1E+09 | 2.7E+09 | 3.0E+09 | 3.2E+09 |
| | Heat resistance | — | A | A | A | A | A | A | A |
| | Surface specific resistance | — | A | A | A | A | A | A | A |

| | | | | | Ex. 8 | Ex. 9 | Ex. 10 | Ex. 11 | Ex. 12 | Ex. 13 | Ex. 14 |
|---|---|---|---|---|---|---|---|---|---|---|---|
| Production | Raw | PET | Type | — | PET-1 | PET-1 | PET-1 | PET-1 | PET-1 | PET-1 | PET-1 |
| conditions | material | | Amount | Parts by mass | 33.3 | 33.3 | 33.3 | 33.3 | 66.7 | 50.0 | 33.3 |
| | | Master pellet | Type | — | MB-2-1 | MB-2-2 | MB-2-3 | MB-2-4 | MB-3-1 | MB-3-1 | MB-3-1 |
| | | (1) | Amount | Parts by mass | 66.7 | 66.7 | 66.7 | 66.7 | 33.3 | 50.0 | 66.7 |
| | | Master pellet | Type | — | — | — | — | — | — | — | — |
| | | (2) | Amount | Parts by mass | — | — | — | — | — | — | — |
| | Stretching | Vertical | Temperature | ° C. | 90 | 90 | 90 | 90 | 90 | 90 | 90 |
| | | stretching | Stretching | Times | 2.5 | 2.5 | 2.5 | 2.5 | 2.5 | 2.5 | 2.5 |
| | | | factor | | | | | | | | |
| | | Transverse | Temperature | ° C. | 90 | 90 | 90 | 90 | 90 | 90 | 90 |
| | | stretching | Stretching | Times | 2.5 | 2.5 | 2.5 | 2.5 | 2.5 | 2.5 | 2.5 |
| | | | factor | | | | | | | | |

| | | | | | | | | | |
|---|---|---|---|---|---|---|---|---|---|
| Physical | Aspect ratio of plate-shaped particle (b1) | — | — | — | — | — | 10 | 10 | 10 |
| properties | Content (Wb1) of plate-shaped particle (b1) | Mass % | — | — | — | — | 10 | 15 | 20 |
| of film | Aspect ratio of needle-shaped particle (b2) | — | 4 | 4 | 4 | 4 | — | — | — |
| | Content (Wb2) of needle-shaped particle (b2) | Mass % | 20 | 20 | 20 | 20 | — | — | — |
| | Wb | Mass % | 20 | 20 | 20 | 20 | 10 | 15 | 20 |
| | V | Volume % | 11 | 8 | 6 | 4 | 4.1 | 6.5 | 9 |
| | V/Wb | — | 0.55 | 0.40 | 0.30 | 0.20 | 0.41 | 0.43 | 0.45 |
| | Wb2/Wb1 | — | — | — | — | — | — | — | — |
| | IV | — | 0.53 | 0.54 | 0.55 | 0.55 | 0.60 | 0.58 | 0.55 |
| | ΔTcg | ° C. | 42.4 | 42.5 | 42.7 | 42.7 | 43.7 | 43.1 | 42.8 |
| | Young's modulus | GPa | 4.7 | 4.7 | 4.7 | 4.6 | 4.0 | 4.3 | 4.5 |
| | Elongation at break | % | 20 | 25 | 25 | 20 | 85 | 50 | 20 |
| | Thermal conductive rate | W/mK | 0.18 | 0.21 | 0.22 | 0.26 | 0.16 | 0.18 | 0.19 |
| | Dynamic storage elastic modulus | Pa | 3.4E+09 | 3.4E+09 | 3.4E+09 | 3.2E+09 | 2.2E+09 | 2.7E+09 | 3.0E+09 |
| | Heat resistance | — | A | A | A | A | A | A | A |
| | Surface specific resistance | — | A | A | A | A | A | A | A |

| | | | | | Ex. 15 | Ex. 16 | Ex. 17 | Ex. 18 | Ex. 19 | Ex. 20 | Ex. 21 |
|---|---|---|---|---|---|---|---|---|---|---|---|
| Production | Raw | PET | Type | — | PET-1 | PET-1 | PET-2 | PET-3 | PET-1 | PET-1 | PET-1 |
| conditions | material | | Amount | Parts by mass | 66.7 | 33.3 | 33.3 | 33.3 | 33.3 | 33.3 | 33.3 |
| | | Master pellet | Type | — | MB-3-2 | MB-3-3 | MB-4-1 | MB-4-2 | MB-1-2 | MB-3-4 | MB-3-4 |
| | | (1) | Amount | Parts by mass | 33.3 | 66.7 | 66.7 | 66.7 | 66.7 | 66.7 | 15.0 |
| | | Master pellet | Type | — | — | — | — | — | — | — | MB-1-2 |
| | | (2) | Amount | Parts by mass | — | — | — | — | — | — | 51.7 |
| | Stretching | Vertical | Temperature | ° C. | 90 | 90 | 90 | 90 | 90 | 90 | 90 |
| | | stretching | Stretching | Times | 2.5 | 2.5 | 2.5 | 2.5 | 2.5 | 2.5 | 2.5 |
| | | | factor | | | | | | | | |
| | | Transverse | Temperature | ° C. | 90 | 90 | 90 | 90 | 90 | 90 | 90 |
| | | stretching | Stretching | Times | 2.5 | 2.5 | 2.5 | 2.5 | 2.5 | 2.5 | 2.5 |
| | | | factor | | | | | | | | |

| | | | | | | | | | |
|---|---|---|---|---|---|---|---|---|---|
| Physical | Aspect ratio of plate-shaped particle (b1) | — | — | — | — | — | — | 19 | 19 |
| properties | Content (Wb1) of plate-shaped particle (b1) | Mass % | — | — | — | — | — | 20.0 | 4.5 |
| of film | Aspect ratio of needle-shaped particle (b2) | — | 3 | 10 | 4 | 4 | 4 | — | 4 |
| | Content (Wb2) of needle-shaped particle (b2) | Mass % | 10 | 20 | 20 | 20 | 20.0 | — | 15.5 |
| | Wb | Mass % | 10 | 20 | 20 | 20 | 20.0 | 20.0 | 20 |
| | V | Volume % | 4.7 | 6.5 | 5 | 4 | 10 | 11 | 9 |
| | V/Wb | — | 0.47 | 0.33 | 0.25 | 0.20 | 0.50 | 0.55 | 0.45 |
| | Wb2/Wb1 | — | — | — | — | — | — | — | 3.4 |
| | IV | — | 0.59 | 0.55 | 0.64 | 0.69 | 0.54 | 0.53 | 0.54 |
| | ΔTcg | ° C. | 43.6 | 43.2 | 45.2 | 46.2 | 42.6 | 42.3 | 42.7 |
| | Young's modulus | GPa | 3.9 | 4.7 | 4.6 | 4.7 | 4.5 | 4.4 | 4.5 |
| | Elongation at break | % | 85 | 15 | 25 | 30 | 20 | 15 | 20 |
| | Thermal conductive rate | W/mK | 0.16 | 0.29 | 0.22 | 0.23 | 0.19 | 0.18 | 0.28 |
| | Dynamic storage elastic modulus | Pa | 2.1E+09 | 3.4E+09 | 3.2E+09 | 3.4E+09 | 3.0E+09 | 2.8E+09 | 3.0E+09 |
| | Heat resistance | — | A | A | A | A | A | A | A |
| | Surface specific resistance | — | A | A | A | A | A | A | A |

| | | | | | Ex. 22 | Ex. 23 | Ex. 24 | Ex. 25 | Ex. 26 | Ex. 27 | Ex. 28 |
|---|---|---|---|---|---|---|---|---|---|---|---|
| Production | Raw | PET | Type | — | PET-1 | PET-1 | PET-1 | PET-1 | PET-1 | PET-1 | PET-1 |
| conditions | material | | Amount | Parts by mass | 33.3 | 33.3 | 33.3 | 33.3 | 33.3 | 33.3 | 70.0 |
| | | Master pellet | Type | — | MB-3-4 | MB-3-4 | MB-3-4 | MB-3-4 | MB-3-4 | MB-3-4 | MB-3-4 |
| | | (1) | Amount | Parts by mass | 7.3 | 8.2 | 36.7 | 30.3 | 6.4 | 46.7 | 6.8 |
| | | Master pellet | Type | — | MB-1-2 | MB-1-2 | MB-1-2 | MB-1-2 | MB-1-2 | MB-1-2 | MB-1-2 |
| | | (2) | Amount | Parts by mass | 59.4 | 58.5 | 30.0 | 36.4 | 60.4 | 20.0 | 23.2 |
| | Stretching | Vertical | Temperature | ° C. | 90 | 90 | 90 | 90 | 90 | 90 | 90 |
| | | stretching | Stretching | Times | 2.5 | 2.5 | 2.5 | 2.5 | 2.5 | 2.5 | 2.5 |
| | | | factor | | | | | | | | |
| | | Transverse | Temperature | ° C. | 90 | 90 | 90 | 90 | 90 | 90 | 90 |
| | | stretching | Stretching | Times | 2.5 | 2.5 | 2.5 | 2.5 | 2.5 | 2.5 | 2.5 |
| | | | factor | | | | | | | | |

| | | | | | | | | | |
|---|---|---|---|---|---|---|---|---|---|
| Physical | Aspect ratio of plate-shaped particle (b1) | — | 19 | 19 | 19 | 19 | 19 | 19 | 19 |
| properties | Content (Wb1) of plate-shaped particle (b1) | Mass % | 2.2 | 2.5 | 11.0 | 9.1 | 1.9 | 14.0 | 2.0 |
| of film | Aspect ratio of needle-shaped particle (b2) | — | 4 | 4 | 4 | 4 | 4 | 4 | 4 |
| | Content (Wb2) of needle-shaped particle (b2) | Mass % | 17.8 | 17.6 | 9.0 | 10.9 | 18.1 | 6.0 | 7.0 |
| | Wb | Mass % | 20 | 20 | 20 | 20 | 20 | 20 | 9.0 |
| | V | Volume % | 9.5 | 9.5 | 9.5 | 9.5 | 10 | 10 | 5.5 |
| | V/Wb | — | 0.47 | 0.47 | 0.47 | 0.47 | 0.50 | 0.50 | 0.61 |
| | Wb2/Wb1 | — | 8.1 | 7.1 | 0.8 | 1.2 | 9.5 | 0.4 | 3.4 |
| | IV | — | 0.54 | 0.54 | 0.54 | 0.54 | 0.54 | 0.54 | 0.62 |
| | ΔTcg | ° C. | 42.6 | 42.7 | 42.6 | 42.6 | 42.6 | 42.5 | 43.7 |
| | Young's modulus | GPa | 4.5 | 4.5 | 4.5 | 4.5 | 4.5 | 4.5 | 3.8 |
| | Elongation at break | % | 20 | 20 | 20 | 20 | 20 | 15 | 90 |
| | Thermal conductive rate | W/mK | 0.25 | 0.26 | 0.25 | 0.26 | 0.22 | 0.21 | 0.18 |
| | Dynamic storage elastic modulus | Pa | 3.0E+09 | 3.0E+09 | 3.0E+09 | 3.0E+09 | 3.0E+09 | 3.0E+09 | 1.9E+09 |
| | Heat resistance | — | A | A | A | A | A | A | A |
| | Surface specific resistance | — | A | A | A | A | A | A | A |

| | | | | | Comp. Ex. 1 | Comp. Ex. 2 | Comp. Ex. 3 | Comp. Ex. 4 | Comp. Ex. 5 | Comp. Ex. 6 | Comp. Ex. 7 | Comp. Ex. 8 |
|---|---|---|---|---|---|---|---|---|---|---|---|---|
| Production | Raw material | PET | Type | — | PET-1 | PET-1 | PET-1 | PET-1 | PET-1 | PET-1 | PET-1 | PET-1 |
| conditions | | | Amount | Parts by mass | 100.0 | 66.7 | 33.3 | 33.3 | 66.7 | 66.7 | 66.7 | 66.7 |
| | | Master pellet (1) | Type | — | — | MB-1-5 | MB-1-5 | MB-1-2 | MB-1-2 | MB-1-3 | MB-1-4 | MB-3-5 |
| | | | Amount | Parts by mass | 0 | 33.3 | 66.7 | 66.7 | 33.3 | 33.3 | 33.3 | 33.3 |
| | | Master pellet (2) | Type | — | — | — | — | — | — | — | — | — |
| | | | Amount | Parts by mass | 0 | — | — | — | — | — | — | — |
| | Stretching | Vertical | Temperature | ° C. | 90 | 90 | 90 | — | 90 | 90 | 90 | 90 |
| | | stretching | Stretching | Times | 2.5 | 2.5 | 2.5 | — | 2.5 | 2.5 | 2.5 | 2.5 |
| | | | factor | | | | | | | | | |
| | | Transverse | Temperature | ° C. | 90 | 90 | 90 | — | 90 | 90 | 90 | 90 |
| | | stretching | Stretching | Times | 2.5 | 2.5 | 2.5 | — | 2.5 | 2.5 | 2.5 | 2.5 |
| | | | factor | | | | | | | | | |

| | | | | | | | | | | |
|---|---|---|---|---|---|---|---|---|---|---|
| Physical properties | Aspect ratio of plate-shaped particle (b1) | — | — | — | — | — | — | — | — | — |
| of film | Content (Wb1) of plate-shaped particle (b1) | Mass % | — | — | — | — | — | — | — | — |
| | Aspect ratio of needle-shaped particle (b2) | — | — | 4 | 4 | 4 | 4 | 4 | 4 | 1 |
| | Content (Wb2) of needle-shaped particle (b2) | Mass % | — | 10 | 20 | 20 | 8 | 8 | 8 | 10 |
| | Wb | Mass % | — | 10 | 20 | 20 | 8 | 8 | 8 | 10 |
| | V | Volume % | 0 | 11 | 23 | 0.4 | 5 | 4 | 4 | 4 |
| | V/Wb | — | — | 1.10 | 1.15 | 0.02 | 0.63 | 0.50 | 0.50 | 0.40 |
| | Wb2/Wb1 | — | — | — | — | — | — | — | — | — |
| | IV | — | 0.60 | 0.50 | 0.48 | 0.60 | 0.60 | 0.60 | 0.61 | 0.61 |
| | ΔTcg | ° C. | 63 | 40.5 | 40 | 43.7 | 43.7 | 43.8 | 43.9 | 43.1 |
| | Young's modulus | GPa | 3.5 | 3.7 | 3.9 | 1.8 | 3.8 | 3.8 | 3.8 | 3.7 |
| | Elongation at break | % | 120 | 50 | 8 | 150 | 20 | 90 | 90 | 90 |
| | Thermal conductive rate | W/mK | 0.13 | 0.13 | 0.13 | 0.20 | 0.13 | 0.13 | 0.13 | 0.13 |
| | Dynamic storage elastic modulus | Pa | 1.5E+09 | 1.8E+09 | 2.1E+09 | 2.0E+07 | 1.9E+09 | 1.9E+09 | 1.9E+09 | 1.8E+09 |
| | Heat resistance | — | A | A | A | D | A | A | A | A |
| | Surface specific resistance | — | A | A | A | A | A | A | A | A |

### INDUSTRIAL APPLICABILITY

We provide a polyester film excellent in electrical insulating properties, thermal conductivity, and mechanical properties compared to conventional polyester films. The polyester film can be suitably used in applications where electrical insulating properties and thermal conductivity are both important, namely, applications including electrical insulating materials such as copper-clad laminates, solar-cell back sheets, adhesive tape, flexible printed boards, membrane switches, heating element sheets, and flat cables as well as capacitor materials, automobile materials, and building materials. More specifically, the polyester film can be used to provide highly efficient wind power generators and solar cells and low-power-consuming small electronic devices.

1-14. (canceled)

15. A polyester film provided with a layer (a P layer) that contains a crystalline polyester (A) and also contains plate-like particles (b1) each having an aspect ratio of 2 or more and/or needle-like particles (b2) each having an aspect ratio of 2 or more, wherein the Young's modulus of the polyester film is 2 GPa or more and the values of Wb and V/Wb are 10 or more and 1 or less, respectively, wherein Wb (% by mass) represents the total content of the plate-like particles (b1) each having an aspect ratio of 2 or more and the needle-like particles (b2) each having an aspect ratio of 2 or more in the P layer, and V (% by volume) represents the porosity in the P layer.

16. The polyester film according to claim 15, wherein the plate-like particle (b1) and the needle-like particle (b2) have on their surfaces a substituent reactive with the crystalline polyester (A) (hereinafter, the substituent is called reactive substituent (a)), and the amount of the reactive substituent (a) on a unit surface area of the particle (B) is not smaller than 0.2×10⁻⁶ mol/m² and not greater than 1.4×10⁻⁴ mol/m².

17. The polyester film according to claim 15, wherein the P layer comprises both the plate-like particle (b1) and the needle-like particle (b2), and a Wb2/Wb1 value is not smaller than 0.7 and not greater than 9, with the content of the plate-like particle (b1) in the P layer being Wb1 (% by mass) and the content of the needle-like particle (b2) in the P layer being Wb2 (% by mass).

18. The polyester film according to claim 15, wherein the elongation at break of the polyester film is not lower than 10%.

19. The polyester film according to claim 15, wherein a difference (ΔTcg) between a glass transition temperature (Tg) of the P layer and a cold crystallization peak top temperature (Tcc) of the P layer is not lower than 44° C.

20. The polyester film according to claim 15, wherein a dynamic storage elastic modulus (E′) at 100° C. determined by dynamic viscoelasticity measurement (hereinafter, called DMA) at a frequency of 1 Hz is not smaller than 5×10⁷ Pa.

21. The polyester film according to claim 15, wherein the polyester film has a thermal conductive rate in a film thickness direction of not lower than 0.15 W/mK and a surface specific resistance of not lower than 10¹³ Ω/□.

22. An electrical insulation sheet comprising the polyester film as claimed in claim 15.

23. A wind power generator comprising the electrical insulation sheet as claimed in claim 22.

24. An adhesive tape comprising the polyester film as claimed in claim 15.

25. A method of producing the polyester film as claimed in claim 15, the method comprising, in sequence:
melt-kneading a crystalline polyester (A) with at least one of a plate-like particle (b1) having an aspect ratio of 2 or more and having a substituent reactive with the crystalline polyester (A) (hereinafter, the substituent is called reactive substituent (a)) on a surface and a needle-like particle (b2) having an aspect ratio of 2 or more and having the reactive substituent (a) on a surface;
melting the resulting resin composition comprising the crystalline polyester (A) and the at least one particle and discharging the resulting resin composition through a nozzle to obtain a film; and
biaxially stretching the resulting film.

26. The method according to claim 25, wherein the amount of the reactive substituent (a) on a unit surface area of the at least one of the plate-like particle (b1) and the needle-like particle (b2) is not smaller than 0.2×10⁻⁶ mol/m² and not greater than 1.4×10⁻⁴ mol/m².

27. The method according to claim 25, wherein the at least one of the plate-like particle (b1) and the needle-like particle (b2) has been treated with a surface-treating agent containing the reactive substituent (a), and the proportion (by mass) of the surface-treating agent is not lower than 0.1 parts by mass and not higher than 5 parts by mass relative to the mass of the particle (B) being defined as 100 parts by mass.

28. The method according to claim 25, wherein the melt-kneading step yields a chip-like composition, then the resulting chip-like composition is subjected to solid-phase polymerization, and then the resultant is melted and subjected to film formation in the melt-extruding step.
